(19) United States
(12) Patent Application Publication
(10) Pub. No.: US 2010/0318707 A1
(43) Pub. Date: Dec. 16, 2010

(54) EXTERNAL DEVICE ACCESS APPARATUS, CONTROL METHOD THEREOF, AND SYSTEM LSI

(75) Inventors: Tsuyoshi Tanaka, Osaka (JP); Nobuo Higaki, Hyogo (JP); Takasi Inoue, Osaka (JP); Yosuke Kudo, Osaka (JP); Kazushi Kurata, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/866,061

(22) PCT Filed: Aug. 13, 2008
(86) PCT No.: PCT/JP2008/002206

§ 371 Date: Aug. 4, 2010

(30) Foreign Application Priority Data
Feb. 8, 2008 (JP) 2008-029356

(51) Int. Cl. G06F 13/24; G06F 9/30

(52) U.S. Cl. 710/267; 712/207; 712/E09.047

(57) ABSTRACT

An external device access apparatus according to the present invention includes: an address control unit that accepts a prefetch request and a prefetch data readout request from a master and performs a prefetch operation and a prefetch data readout operation; a readout data storage unit that stores data read out through the prefetch operation; a storage operation status holding unit that holds a prefetch operation status indicating whether or not the prefetch operation has been completed; and an acceptance signal generation unit that outputs, to the master, an acceptance signal indicating that the prefetch data readout request has been accepted from the master. First information indicating a status of the prefetch operation is outputted to the master based on the prefetch operation status.

### TECHNICAL FIELD

The present invention relates to an external device access apparatus, a control method thereof, and a system LSI, and relates particularly to an external device access apparatus that makes a prefetch access to an external device in response to a request from a master.

### BACKGROUND ART

There are cases in media processing where it is useful for an external device to assist a master. For this reason, there are cases where the master includes an expansion bus for expanding the external device.

Here, “media processing” refers generally to data processing such as audio processing, image processing, and so on; “master” refers to an apparatus that undertakes primary control, such as a CPU, a microprocessor, or the like; and “external device” refers to a peripheral apparatus such as a coprocessor, an accelerator, a memory, or the like that assists the CPU, the microprocessor, or the like.

The master can handle resources of the external device as expanded resources of the master itself by allocating the resources of the external device to an access area. Through this, it is possible for the master and the external device to communicate at high speeds. Here, “access area” refers to an area, capable of being accessed by the master, in which addresses have been allocated for program access, data access, input/output access, and so on.

A method called “prefetching” is used in order to improve the processing performance of the master with respect to the external device. “Prefetching” is a method in which the master makes readout requests in advance, acquires the data read out in advance after a certain latency interval, and performs the next process.

For example, an external device access apparatus that performs a prefetch operation on an external device in response to a request from a master is known (for example, see Patent Reference 1). The conventional external device access apparatus disclosed in Patent Reference 1 performs a prefetch operation that reads out data from the external device in response to a request from a master and temporarily stores the read-out data, and a prefetch data readout operation that outputs the stored data to the master.

Meanwhile, with the conventional external device access apparatus, in the case where the prefetch data readout operation is performed in response to a request from the master while the prefetch operation is being performed on the external device, the read-out data is outputted to the master in synchronization with the completion of the prefetch operation. This makes it possible to avoid outputting erroneous data to the master prior to the completion of the prefetch operation.

FIG. 1 is a flowchart illustrating the flow of processing performed by the master in the case where the conventional external device access apparatus is used.

First, the master performs a prefetch operation on the external device (S501). Next, the master performs processing that can be executed prior to the readout of the prefetch data (S502). Here, the interval in which the master performs the processing is the interval spanning until the prefetch operation is completed when the external device is in a normal state. Next, the master reads out the prefetch data (S503). In the case where the prefetch operation is complete (No in S504), the master executes processing using the read-out data (S505). If the external device has responded within a certain interval following the completion of the prefetch operation in this manner, then there is no problem.

Patent Reference 1: International Publication WO 2006/134804 pamphlet

### DISCLOSURE OF INVENTION

### Problems that Invention is to Solve

However, in the case where the prefetch operation has not been completed (Yes in S504) due to an error state in the external device, competition for access from another master, or the like, the master enters a standby state until the prefetch operation has been completed. As a result, the conventional technique has a problem in that the processing efficiency of the master drops.

Having been conceived in order to solve the aforementioned problem, it is an object of the present invention to provide an external device access apparatus and a system LSI capable of efficiently utilizing a master.

### Means to Solve the Problems

In order to solve the aforementioned problem, an external device access apparatus according to an implementation of the present invention performs, in response to a request from a master, a prefetch operation of reading out data from an external device and a prefetch data readout operation of outputting the data read out through the prefetch operation to the master, and includes: a control unit that accepts a prefetch request and a prefetch data readout request from the master and performs the prefetch operation and the prefetch data readout operation; a data storage unit that stores the data read out through the prefetch operation; a status holding unit that holds a prefetch operation status indicating whether or not the prefetch operation has been completed; and an acceptance signal generation unit that outputs, to the master, an acceptance signal indicating that the prefetch data readout request from the master has been accepted. The control unit outputs the data stored in the data storage unit to the master as the prefetch data readout operation; and the control unit outputs first information indicating a status of the prefetch operation to the master, the status being based on the prefetch operation status.

According to this configuration, the external device access apparatus according to an implementation of the present invention outputs the first information, indicating the status of the prefetch operation, to the master. Through this, the master can perform other processes first in the case where the prefetch operation is not complete at the point in time of the prefetch data readout operation. Accordingly, the external device access apparatus according to the present invention can use the master efficiently.

In addition, the acceptance signal generation unit may output the acceptance signal to the master, regardless of whether or not the prefetch operation has been completed, when the prefetch data readout request is accepted by the control unit; and the control unit may output the first information to the master upon accepting the prefetch data readout request.

According to this configuration, by receiving the acceptance signal, the master can perform other processes first in the case where the prefetch operation has not been completed.

In addition, the control unit may output the prefetch operation status to the master as the first information.

According to this configuration, the master can determine whether or not the external device access apparatus has completed the prefetch operation.

In addition, the external device access apparatus and the master may be connected via a readout data bus; and the control unit may output the data stored in the data storage unit and the first information to the master via the readout data bus.

According to this configuration, there is no need to provide a dedicated bus for outputting the first information from the external device access apparatus to the master.

In addition, the control unit may output the data stored in the data storage unit to the master via the readout data bus in the case where the prefetch operation status indicates that the prefetch operation has been completed, and may output pre-set data as the first information to the master via the readout data bus in the case where the prefetch operation status indicates that the prefetch operation has not been completed.

In addition, the control unit may output the data stored in the data storage unit to the master via the readout data bus in the case where the prefetch operation status indicates that the prefetch operation has been completed, and may output an address of the external device, for which the readout is being performed through the prefetch operation, as the first information to the master via the readout data bus in the case where the prefetch operation status indicates that the prefetch operation has not been completed.

In addition, the control unit may further accept a prefetch operation status readout request from the master; and the control unit may output the first information to the master in the case where the prefetch operation status readout request has been accepted.

According to this configuration, by performing the prefetch operation status readout request before the prefetch data readout operation, the master need not perform an unnecessary prefetch data readout request.

In addition, the external device may output a status signal indicating an operational status of the external device, and the external device access apparatus may further include: a status signal storage unit that stores the status signal at the point in time of the completion of the prefetch operation; and a status signal output unit that outputs the status signal stored in the status signal storage unit to the master in the case where the prefetch operation status indicates that the prefetch operation has been completed, and output the status signal outputted by the external device to the master in the case where the prefetch operation status indicates that the prefetch operation has not been completed.

According to this configuration, the master can be aware of the status of the external device while the prefetch is being executed. Accordingly, the master can perform the optimum process based on the status of the external device.

In addition, the external device may output a status signal indicating an operational status of said external device, and the acceptance signal generation unit may selectively perform, when the prefetch data readout request has been accepted by the control unit and based on the status signal, a first operation that outputs the acceptance signal to the master regardless of whether or not the prefetch operation has been completed or a second operation that outputs the acceptance signal to the master after the prefetch operation has been completed.

According to this configuration, the external device access apparatus according to an implementation of the present invention can select whether to immediately output the acceptance signal or output the acceptance signal after the prefetch operation has been completed, based on the status of the external device. Through this, even with an external device whose latency until the completion of the prefetch is normally variable, the master need not always carry out the prefetch data readout operation having provided the maximum latency interval, and may instead carry out the prefetch data readout operation having provided the minimum latency interval.

In addition, the control unit may further accept a prefetch stopping request from the master, and the external device access apparatus may further include a prefetch stopping unit that stops the prefetch operation in the case where the prefetch stopping request has been accepted by the control unit.

According to this configuration, the master can stop the prefetch operation based on the status of the external device.

In addition, the external device may output status signal indicating an operational status of the external device, and the external device access apparatus may further include a prefetch stopping unit that stops the prefetch operation based on the status signal outputted by the external device in the case where the prefetch data readout request has been accepted by the control unit and the prefetch operation status indicates that the prefetch operation has not been completed.

According to this configuration, in the case where the prefetch operation is being executed and the external device is in an error state at the time of the prefetch data readout operation, the external device access apparatus according to an implementation of the present invention automatically stops the prefetch operation. Through this, the master need not perform control for stopping the prefetch operation. Accordingly, the external device access apparatus according to an implementation of the present invention can reduce the processing performed by the master.

In addition, the external device may output a status signal indicating an operational status of said external device; the external device access apparatus and the master may be connected via a first signal bus; and the external device access apparatus may further include: a status signal storage unit that stores the status signal at the point in time of the completion of the prefetch operation; a readout time status storage unit that stores a readout time prefetch operation status that is the prefetch operation status at the point in time when the prefetch data readout request has been accepted by the control unit; and a signal output unit that outputs the prefetch operation status to the master via the first signal bus in the case where the prefetch operation status indicates that the prefetch operation has not been completed, and output the status signal stored in the status signal storage unit to the master via the first signal bus in the case where the prefetch operation status indicates that the prefetch operation has been completed. The control unit may output the readout time prefetch operation status to the master as the first information in the case where the prefetch operation status readout request has been accepted.

According to this configuration, the external device access apparatus according to an implementation of the present invention outputs the prefetch operation status and the status signal to the master via the first signal bus. Through this, a bus for outputting the prefetch operation status and a bus for outputting the status signal need not be provided individually.

In addition, the acceptance signal generation unit may selectively perform, when the prefetch data readout request has been accepted by the control unit, a first operation that outputs the acceptance signal to the master regardless of whether or not the prefetch operation has been completed or a second operation that outputs the acceptance signal to the master after the prefetch operation has been completed.

According to this configuration, the external device access apparatus according to an implementation of the present invention can select whether to immediately output the acceptance signal or output the acceptance signal after the prefetch operation has been completed.

In addition, the acceptance signal generation unit may selectively perform the first operation or the second operation based on a control signal outputted by the master.

According to this configuration, the master can select between the first operation and the second operation.

In addition, the prefetch data readout request may include a first prefetch data readout request and a second prefetch data readout request; the control unit may accept the first prefetch data readout request in the case where a first address has been outputted by the master, and accept the second prefetch data readout request in the case where a second address has been outputted by the master; and the acceptance signal generation unit may perform the first operation in the case where the first prefetch data readout request has been accepted by the control unit, and perform the second operation in the case where the second prefetch data readout request has been accepted by the control unit.

According to this configuration, the master can select between the first operation and the second operation without providing a new bus for control between the external device access apparatus and the master.

In addition, the external device access apparatus may further include a status setting unit in which a first status or a second status is set, and the control unit may further accept a prefetch readout control operation request from the master; the control unit may sets the first status or the second status in the status setting unit as instructed by the master in the case where the prefetch readout control operation request has been accepted; and the acceptance signal generation unit may perform the first operation in the case where the first status is set in the status setting unit, and perform the second operation in the case where the second status is set in the status setting unit.

According to this configuration, the master can select between the first operation and the second operation without providing a new bus for control between the external device access apparatus and the master.

In addition, the external device access apparatus may further include a count unit that may, in the case where a prefetch data readout request has been accepted by the control unit while the prefetch operation is being executed, count the time from when the prefetch data readout request is accepted until the prefetch operation is completed, and the control unit may output the time counted by the count unit as the first information to the master.

According to this configuration, the master can change the timing at which the prefetch data readout operation is requested to a time that is after the completion of the prefetch operation. Accordingly, because the master need not request the prefetch data readout operation multiple times, the efficiency can be improved.

In addition, the control unit may further accept a time readout request from the master, and the external device access apparatus may further include a time storage unit that stores the time counted by the count unit; the control unit may output the time stored in the time storage unit as the first information to the master in the case where a time readout request has been accepted.

According to this configuration, the external device access apparatus can notify the master of the time taken until the prefetch operation is completed without providing a new signal output bus between the external device access apparatus and the master.

In addition, a system LSI according to an implementation of the present invention includes the aforementioned external device access apparatus and a master; the external device access apparatus outputs the first information as an interrupt signal or as a thread switching signal for the master; and the master processes the first information as an interrupt or as a thread switching signal.

In addition, a system LSI according to an implementation of the present invention includes the aforementioned external device access apparatus and a master; the external device access apparatus outputs the first information as a flag signal that can be processed by the master through software; and the master processes the first information as a flag signal that can be processed through software.

In addition, a system LSI according to an implementation of the present invention includes the aforementioned external device access apparatus and a master; the master outputs the control signal to the external device access apparatus in synchronization with the prefetch data readout request.

According to this configuration, the master synchronizes the output of the readout acceptance control signal with the prefetch data readout request based on a command from a CPU, a microprocessor, or the like, and thus the master can select between two processes during each prefetch readout operation. Accordingly, the master can perform a more optimum process.

In addition, a control method according to an implementation of the present invention is a control method for an external device access apparatus that performs, in response to a request from a master, a prefetch operation of reading out data from an external device and a prefetch data readout operation of outputting the data read out in the prefetch operation to the master, the method including: accepting a prefetch request from the master; reading out data from said external device and storing the read-out data in a data storage unit in the case where the prefetch request has been accepted; holding a prefetch operation status indicating whether or not said storing has been completed; accepting a prefetch data readout request from said master; outputting, to said master, an acceptance signal indicating that the prefetch data readout request has been accepted in the case where the prefetch data readout request has been accepted; outputting the data stored in said data storage unit to said master in the case where the prefetch data readout request has been accepted; and outputting first information indicating a status of the prefetch operation to said master based on the prefetch operation status.

According to this method, the control method for an external device access apparatus according to the present invention outputs the first information, indicating the status of the prefetch operation, to the master. Through this, the master can perform other processes first in the case where the prefetch operation is not complete at the point in time of the prefetch data readout operation. Accordingly, the control method for an external device access apparatus according to the present invention can use the master efficiently.

It should be noted that the present invention can be implemented not only as such an external device access apparatus, but can also be implemented as a control method for an external device access apparatus in which the characteristic units included in the external device access apparatus are implemented as steps, and as a program that causes a computer to execute those characteristic steps. It goes without saying that such a program can then be distributed via a recording medium such as a CD-ROM or the like and a transmission medium such as the Internet or the like.

### EFFECTS OF THE INVENTION

The present invention can provide an external device access apparatus, a control method therefor, and a system LSI capable of using a master efficiently.

### BRIEF DESCRIPTION OF DRAWINGS

FIG. 1 is a flowchart illustrating the flow of prefetch processing performed by a master in the case where a conventional external device access apparatus is used.

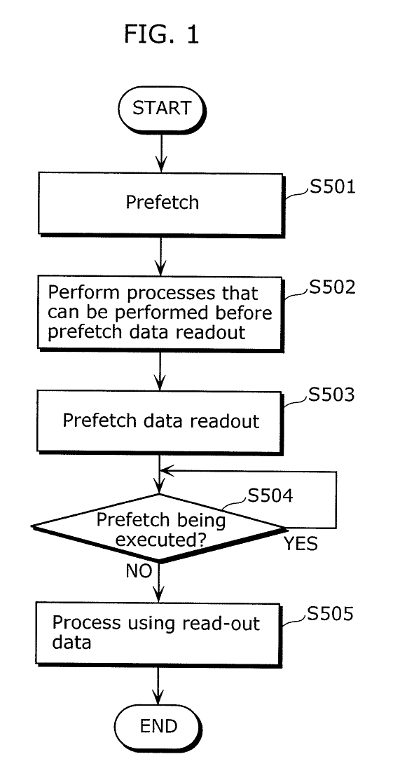

FIG. 2 is a block diagram illustrating the configuration of an external device access apparatus according to a first embodiment of the present invention.

FIG. 3 is a flowchart illustrating the flow of prefetch processing performed by a master in the case where an external device access apparatus according to the first embodiment of the present invention is used.

FIG. 4 is a block diagram illustrating the configuration of an external device access apparatus according to a second embodiment of the present invention.

FIG. 5 is a block diagram illustrating the configuration of a variation on the external device access apparatus according to the second embodiment of the present invention.

FIG. 6 is a block diagram illustrating the configuration of an external device access apparatus according to a third embodiment of the present invention.

FIG. 7 is a block diagram illustrating the configuration of an external device access apparatus according to a fourth embodiment of the present invention.

FIG. 8 is a block diagram illustrating the configuration of an external device access apparatus according to a fifth embodiment of the present invention.

FIG. 9 is a block diagram illustrating the configuration of an external device access apparatus according to a sixth embodiment of the present invention.

FIG. 10 is a block diagram illustrating the configuration of an external device access apparatus according to a seventh embodiment of the present invention.

FIG. 11 is a block diagram illustrating the configuration of an external device access apparatus according to an eighth embodiment of the present invention.

FIG. 12 is a block diagram illustrating the configuration of an external device access apparatus according to a ninth embodiment of the present invention.

FIG. 13 is a block diagram illustrating the configuration of an external device access apparatus according to a tenth embodiment of the present invention.

FIG. 14 is a block diagram illustrating the configuration of an external device access apparatus according to an eleventh embodiment of the present invention.

FIG. 15 is a block diagram illustrating the configuration of an external device access apparatus according to a twelfth embodiment of the present invention.

### NUMERICAL REFERENCES

101 master
102 external device
103, 203, 213, 303, 403, 503, 603, 703, 803, 903, 1003, 1103, 1203 external device access apparatus
110 write address storage unit
111 write data storage unit
112, 612 readout address storage unit
113 readout data storage unit
114, 314, 614, 1014, 1214 address control unit
115, 615, 815 storage operation status holding unit
116, 516, 916, 1016, 1116 acceptance signal generation unit
117 status signal storage unit
118 cycle count unit
130 error data generation unit
131, 731 prefetch stopping control unit
132 readout control unit
133 count value storage unit
140, 141, 142, 143, 144, 145 selector
150 address bus
151 write data input bus
152 readout data output bus
153 R/W signal bus
155 acceptance signal bus
156 prefetch operation status signal bus
157 external device status signal output bus
158 readout acceptance control signal bus
159 debug information bus
160 write address
161 write enabling signal
162 readout address
163 readout address enabling signal
164 readout data enabling signal
165 prefetch operation status signal
170 write address output bus
171 write data output bus
172 readout address output bus
173 readout data input bus
174 external device status signal input bus
175 readout stopping signal bus
180 error data
181 storage operation status readout enabling signal
182 prefetch data readout time status signal
183 readout control signal
184 count value readout enabling signal

### BEST MODE FOR CARRYING OUT THE INVENTION

Embodiments of an external device access apparatus according to the present invention will be described in detail hereinafter with reference to the drawings.

In the embodiments described hereinafter, a “master” is an apparatus that handles the control of writing and reading, such as a CPU, a microprocessor, or the like. An “external device” is an apparatus such as a coprocessor, an accelerator, or the like that assists the CPU, the microprocessor, or the like. In addition, the external device has resources that can be accessed by the master specifying an address.

### First Embodiment

During a prefetch data readout operation, an external device access apparatus according to a first embodiment of the present invention outputs, to a master, an acceptance signal indicating that the prefetch data readout operation has been accepted and a prefetch operation status signal indicating whether or not a prefetch operation has been completed, in the case where the prefetch operation has not been completed.

Through this, the master can perform other processes in the case where the prefetch operation is not complete. Accordingly, the external device access apparatus according to the first embodiment of the present invention is capable of utilizing the master efficiently.

First, the configuration of the external device access apparatus according to the first embodiment of the present invention will be described.

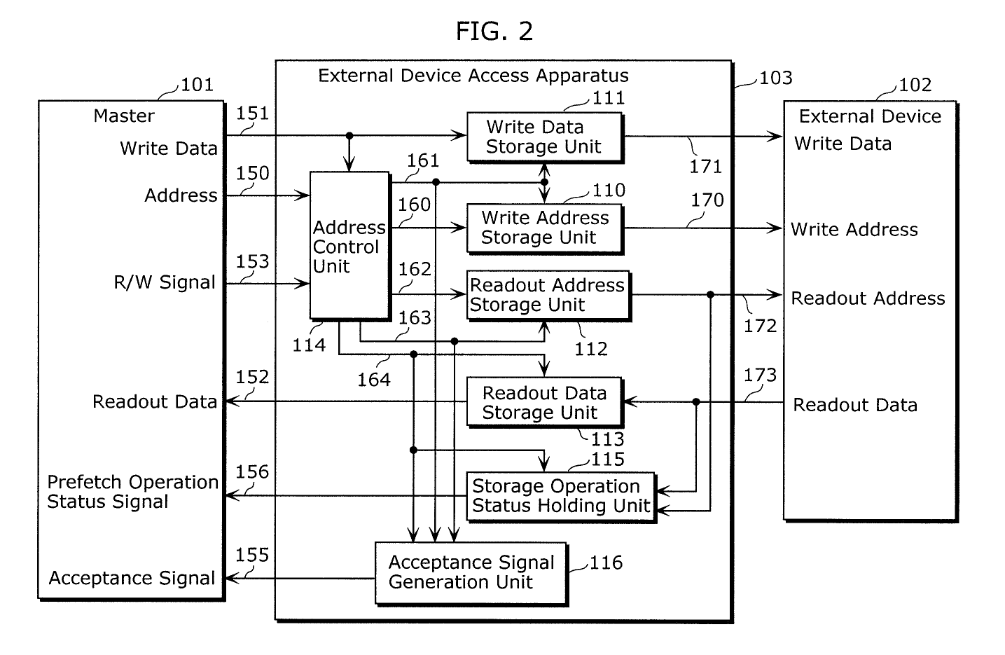

FIG. 2 is a block diagram illustrating the configuration of the external device access apparatus according to the first embodiment of the present invention.

An external device access apparatus 103 is connected to a master 101 via an address bus 150, a write data input bus 151, a readout data output bus 152, a write/read control signal (called an “R/W signal” hereinafter) bus 153, an acceptance signal bus 155, and a prefetch operation status signal bus 156. The external device access apparatus 103 is also connected to an external device 102 via a write address output bus 170, a write data output bus 171, a readout address output bus 172, and a readout data input bus 173.

The external device access apparatus 103 carries out a normal writing operation, a prefetch operation, and a prefetch data readout operation. The normal writing operation is an operation for performing a normal data write into the external device 102. The prefetch operation is an operation for storing data of the external device 102 in a readout data storage unit 113 in advance. The prefetch data readout operation is an operation for outputting data to be stored in the readout data storage unit 113 to the master 101.

The master 101 requests the normal writing operation, the prefetch operation, and the prefetch data readout operation of the external device access apparatus 103.

The external device access apparatus 103 carries out the normal writing operation, the prefetch operation, and the prefetch data readout operation in response to the request from the master 101.

The external device 102 stores the write data outputted through the write data output bus 171 in a write address outputted through the write address output bus 170. Meanwhile, the external device 102 reads out data held in a readout address outputted through the readout address output bus 172 and outputs the read-out data through the readout data input bus 173.

The master 101, the external device 102, and the external device access apparatus 103 are, for example, included within a single system LSI. Note that of the master 101, the external device 102, and the external device access apparatus 103, two or more may be included within a single system LSI, or may be formed as individual respective LSIs.

The external device access apparatus 103 includes a write address storage unit 110, a write data storage unit 111, a readout address storage unit 112, the readout data storage unit 113, an address control unit 114, a storage operation status holding unit 115, and an acceptance signal generation unit 116.

The address control unit 114 accepts, from the master 101, a request for the normal writing operation (a “normal write request” hereinafter), a request for the prefetch operation (a “prefetch request” hereinafter), and a request for the prefetch data readout operation (a “prefetch data readout request” hereinafter). The address control unit 114 accepts the normal write request, the prefetch request, and the prefetch data readout request based on an address outputted by the master 101 through the address bus 150, the write data outputted by the master 101 through the write data input bus 151, and the R/W signal outputted by the master 101 through the R/W signal bus 153.

To be more specific, in the case where the address outputted through the address bus 150 is not an address that has been allocated to the readout data storage unit 113 and a data write has been instructed by the R/W signal, the address control unit 114 recognizes that the request from the master 101 is a normal write request, and accepts the normal write request.

Here, the readout data storage unit 113 has an address allocated to an access space used by the master 101, and is capable of being accessed by the master 101. Here, “capable of being accessed” means that the master 101 can carry out at least one of reading out data stored in the readout data storage unit 113 or writing data into the readout data storage unit 113 by specifying an address of the readout data storage unit 113.

Meanwhile, in the case where the address outputted through the address bus 150 is an address allocated to the readout data storage unit 113 and a data write has been instructed by the R/W signal, the address control unit 114 recognizes that the request from the master 101 is a prefetch request, and accepts the prefetch request.

Furthermore, in the case where the address outputted through the address bus 150 is an address allocated to the readout data storage unit 113 and a data readout has been instructed by the R/W signal, the address control unit 114 recognizes that the request from the master 101 is a prefetch data readout request, and accepts the prefetch data readout request.

The address control unit 114 performs the normal writing operation, the prefetch operation, and the prefetch data readout operation in response to the normal write request, the prefetch request, and the prefetch data readout request. The address control unit 114 performs the normal writing operation, the prefetch operation, and the prefetch data readout operation by controlling the write address storage unit 110, the write data storage unit 111, the readout address storage unit 112, the readout data storage unit 113, the storage operation status holding unit 115, and the acceptance signal generation unit 116.

To be more specific, the address control unit 114 generates a write address 160, a write enabling signal 161, a readout address 162, a readout address enabling signal 163, and a readout data enabling signal 164 in response to the normal write request, the prefetch request, and the prefetch data readout request.

When the normal write request has been accepted, the address control unit 114 outputs the data on the write data input bus 151 as the write address 160, and outputs the write enabling signal 161. When the prefetch request has been accepted, the address control unit 114 outputs the data on the write data input bus 151 as the readout address 162, and outputs the readout address enabling signal 163. When the prefetch data readout request has been accepted, the address control unit 114 outputs the readout data enabling signal 164.

When the write enabling signal 161 has been outputted by the address control unit 114, the write address storage unit 110 acquires the write address 160 and stores the acquired write address 160. The write address storage unit 110 outputs the write address 160 to be stored to the write address output bus 170.

When the write enabling signal 161 has been outputted by the address control unit 114, the write data storage unit 111 acquires the write data on the write data input bus 151, and stores the acquired write data. The write data storage unit 111 outputs the write data to be stored to the write data output bus 171.

When the readout address enabling signal 163 has been outputted by the address control unit 114, the readout address storage unit 112 acquires the readout address 162, and stores the acquired readout address 162. The readout address storage unit 112 outputs the readout address 162 to be stored to the readout address output bus 172.

The readout data storage unit 113 stores the readout data outputted through the readout data input bus 173. In other words, the readout data storage unit 113 stores the data that was read out through the prefetch operation. When the readout data enabling signal 164 has been outputted by the address control unit 114, the readout data storage unit 113 outputs the readout data to be stored to the readout data output bus 152.

The storage operation status holding unit 115 holds the prefetch operation status signal, which is information indicating whether or not the readout data storage unit 113 is in the process of storing the readout data outputted by the external device 102. To rephrase, the prefetch operation status signal is information indicating whether or not the prefetch operation has been completed.

To be more specific, the storage operation status holding unit 115 holds information indicating whether or not the storage operation is underway when the readout address has been outputted to the readout address output bus 172 by the readout address storage unit 112. When the readout data has been outputted to the readout data input bus 173 by the external device 102, the storage operation status holding unit 115 deletes the held information indicating that the storage operation is underway, and then holds information indicating that the storage operation has been completed.

In addition, when the readout data enabling signal 164 has been outputted by the address control unit 114, the storage operation status holding unit 115 outputs the held prefetch operation status signal to the prefetch operation status signal bus 156.

The acceptance signal generation unit 116 outputs an acceptance signal to the master 101, indicating that the normal write request, the prefetch request, and the prefetch data readout request have been accepted from the master 101. To be more specific, when the write enabling signal 161, the readout address enabling signal 163, or the readout data enabling signal 164 has been outputted by the address control unit 114, the acceptance signal generation unit 116 outputs the acceptance signal to the acceptance signal bus 155.

Meanwhile, when the prefetch data readout request has been accepted, the acceptance signal generation unit 116 immediately outputs the acceptance signal to the master 101 regardless of whether or not the prefetch operation is complete.

Next, operations of the external device access apparatus 103 will be described.

First, the normal writing operation will be described.

At the time of the normal writing operation, the master 101 outputs the write data to the write data input bus 151, outputs the write address to the address bus 150, and outputs the R/W signal, instructing a data write, to the R/W signal bus 153. Here, the write address outputted to the address bus 150 by the master 101 is a different address than the address allocated to the readout data storage unit 113.

The address control unit 114 determines whether or not the address on the address bus 150 is the address allocated to the readout data storage unit 113. Because the address on the address bus 150 is not the address allocated to the readout data storage unit 113, and because a data write has been instructed by the R/W signal, the address control unit 114 recognizes that the request from the master 101 is for the normal writing operation. In other words, the address control unit 114 accepts the normal write request from the master 101.

Having accepted the normal write request, the address control unit 114 outputs the write address 160, which is the address on the address bus 150, to the write address storage unit 110. Furthermore, the address control unit 114 outputs the write enabling signal 161 to the write address storage unit 110, the write data storage unit 111, and the acceptance signal generation unit 116.

The write address storage unit 110 stores the write address 160 in response to the write enabling signal 161. The write data storage unit 111 stores the write data of the write data input bus 151 in response to the write enabling signal 161. The acceptance signal generation unit 116 outputs the acceptance signal to the acceptance signal bus 155 at the point in time where the write address 160 and the write data have been stored in the write address storage unit 110 and the write data storage unit 111, respectively, in response to the write enabling signal 161.

The write address storage unit 110 outputs the stored write address 160 through the write address output bus 170. The write data storage unit 111 outputs the stored write data to the write data output bus 171. The write address storage unit 110 and the write data storage unit 111 hold the stored write address and write data, respectively, until the address and data are accepted by the external device 102.

The external device access apparatus 103 completes the normal writing operation after the external device 102 has completed the acceptance.

The prefetch operation will be described next.

At the time of the prefetch operation, the master 101 outputs the readout address to the write data input bus 151, outputs the address allocated to the readout data storage unit 113 to the address bus 150, and outputs the R/W signal instructing a data write to the R/W signal bus 153.

The address control unit 114 determines whether or not the address on the address bus 150 is the address allocated to the readout data storage unit 113. Because the address on the address bus 150 is the address allocated to the readout data storage unit 113, and because a data write has been instructed by the R/W signal, the address control unit 114 recognizes that the request from the master 101 is for the prefetch operation. In other words, the address control unit 114 accepts the prefetch request from the master 101.

Having accepted the prefetch request, the address control unit 114 outputs the readout address 162, which is the data on the write data input bus 151, to the readout address storage unit 112. Meanwhile, the address control unit 114 outputs the readout address enabling signal 163 to the readout address storage unit 112 and the acceptance signal generation unit 116.

The readout address storage unit 112 stores the readout address 162 in response to the readout address enabling signal 163. The acceptance signal generation unit 116 outputs the acceptance signal to the acceptance signal bus 155 at the point in time where the readout address 162 has been stored in the readout address storage unit 112, in response to the readout address enabling signal 163.

The readout address storage unit 112 outputs the stored readout address 162 to the readout address output bus 172. Meanwhile, the readout address storage unit 112 indicates that the storage operation in underway by outputting the stored readout address 162 to the storage operation status holding unit 115.

The storage operation status holding unit 115 receives the readout address outputted by the readout address storage unit 112, and holds information indicating that the storage operation is underway.

Having accepted the readout address, the external device 102 outputs the readout data to the readout data input bus 173.

The readout data storage unit 113 stores the readout data outputted through the readout data input bus 173. Meanwhile, based on the readout data outputted through the readout data input bus 173, the storage operation status holding unit 115 deletes the held information indicating that the storage process is underway.

In addition, the readout address storage unit 112 stores the readout address 162 until the readout data outputted through the readout data input bus 173 is stored in the readout data storage unit 113.

The prefetch operation is completed through the operations described thus far.

The prefetch data readout operation will be described next.

At the time of the prefetch data readout operation, the master 101 outputs the address allocated to the readout data storage unit 113 to the address bus 150, and outputs the R/W signal instructing a data readout to the R/W signal bus 153.

The address control unit 114 determines whether or not the address on the address bus 150 is the address allocated to the readout data storage unit 113. Because the address on the address bus 150 is the address allocated to the readout data storage unit 113, and because a data readout has been instructed by the R/W signal, the address control unit 114 recognizes that the request from the master 101 is for the prefetch data readout operation. In other words, the address control unit 114 accepts the prefetch data readout request from the master 101.

Having accepted the prefetch data readout request, the address control unit 114 outputs the readout data enabling signal 164 to the readout data storage unit 113, the storage operation status holding unit 115, and the acceptance signal generation unit 116.

Based on the readout data enabling signal 164, the readout data storage unit 113 outputs the stored data to the readout data output bus 152.

Meanwhile, based on the readout data enabling signal 164, the storage operation status holding unit 115 outputs the prefetch operation status signal to the prefetch operation status signal bus 156. In the case where the storage operation status holding unit 115 holds information indicating that the storage operation is underway, the prefetch operation status signal indicating that the prefetch operation is being executed is outputted, whereas in the case where the storage operation status holding unit 115 does not hold information indicating that the storage operation is underway, the prefetch operation status signal indicating that the prefetch operation is not being executed is outputted.

Based on the readout data enabling signal 164, the acceptance signal generation unit 116 outputs the acceptance signal to the acceptance signal bus 155. Here, the acceptance signal generation unit 116 outputs the acceptance signal to the acceptance signal bus 155 even if the prefetch operation is underway.

The prefetch data readout operation is completed through the operations described thus far.

Next, operations of the master 101 connected to the external device access apparatus 103 according to the first embodiment of the present invention will be described.

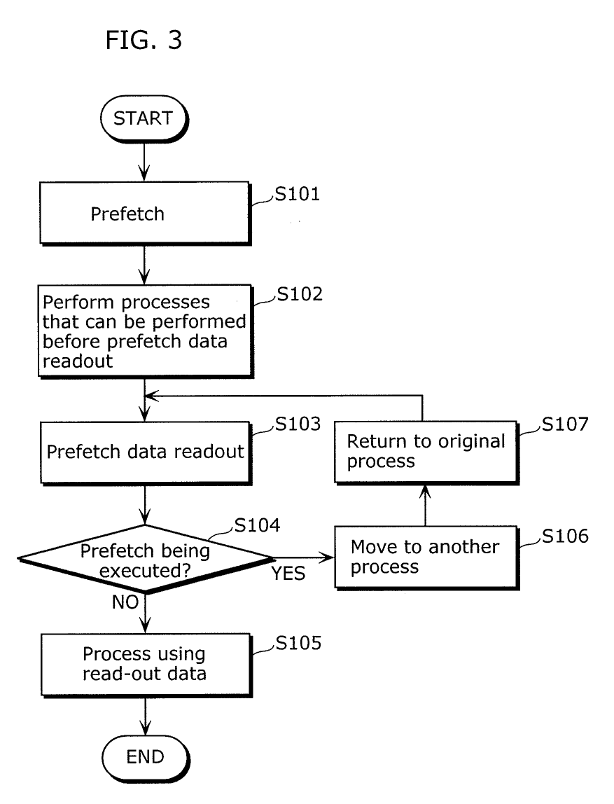

FIG. 3 is a flowchart illustrating the flow of a prefetch process performed by the master 101.

As shown in FIG. 3, first, the master 101 requests a prefetch operation of the external device access apparatus 103 (S101).

Next, the master 101 performs processing that can be executed prior to the prefetch data readout operation (S102). Here, the interval in which the master 101 performs the processing is the interval spanning until the prefetch operation is completed by the external device access apparatus 103 in a normal state.

Next, the master 101 requests a prefetch data readout operation of the external device access apparatus 103 (S103).

Based on the acceptance signal outputted through the acceptance signal bus 155, the master 101 confirms the prefetch operation status signal outputted through the prefetch operation status signal bus 156 and determines whether or not the prefetch operation is being executed (S104).

In the case where the prefetch operation is complete (No in S104), the master 101 executes processing using the readout data outputted through the readout data output bus 152 (S105).

However, in the case where the prefetch operation has not been completed (Yes in S104) due to an error state in the external device 102, competition for access from another master, or the like, the master 101 shifts to the next process or a different process and executes that process (S106).

Next, the master 101 returns to the original process after a predetermined amount of time (S107), and then once again requests a prefetch data readout operation of the external device access apparatus 103 (S103).

As described thus far, in the prefetch data readout operation, the external device access apparatus 103 outputs the acceptance signal to the master 101 even if a prefetch operation is being executed due to an error state in the external device 102 or the like. Through this, the prefetch data readout operation can be completed. Accordingly, the master 101 can shift to the next process even in the case where the prefetch operation has not been completed due to an error state in the external device 102 or the like.

In addition, the external device access apparatus 103 outputs the prefetch operation status signal. Through this, the master 101 can determine whether or not a prefetch operation is being executed at the time of the prefetch data readout operation. Through this, the master 101 can perform other processes in the case where the prefetch operation is not complete. Accordingly, the external device access apparatus 103 according to the first embodiment of the present invention is capable of utilizing the master 101 efficiently.

Note that the external device access apparatus 103 may output the prefetch operation status signal as an interrupt signal, a thread switching signal, or a flag signal that the master is capable of processing through software, and the master 101 may then process the prefetch operation status signal as an interrupt signal, a thread switching signal, or a flag signal that the master is capable of processing through software.

### Second Embodiment

An external device access apparatus according to a second embodiment of the present invention is a variation on the external device access apparatus 103 according to the aforementioned first embodiment. The external device access apparatus according to the second embodiment outputs, to the readout data output bus 152, data indicating that an error has occurred in the case where the prefetch operation is not complete at the time of the prefetch data readout operation.

First, the configuration of the external device access apparatus according to the second embodiment of the present invention will be described.

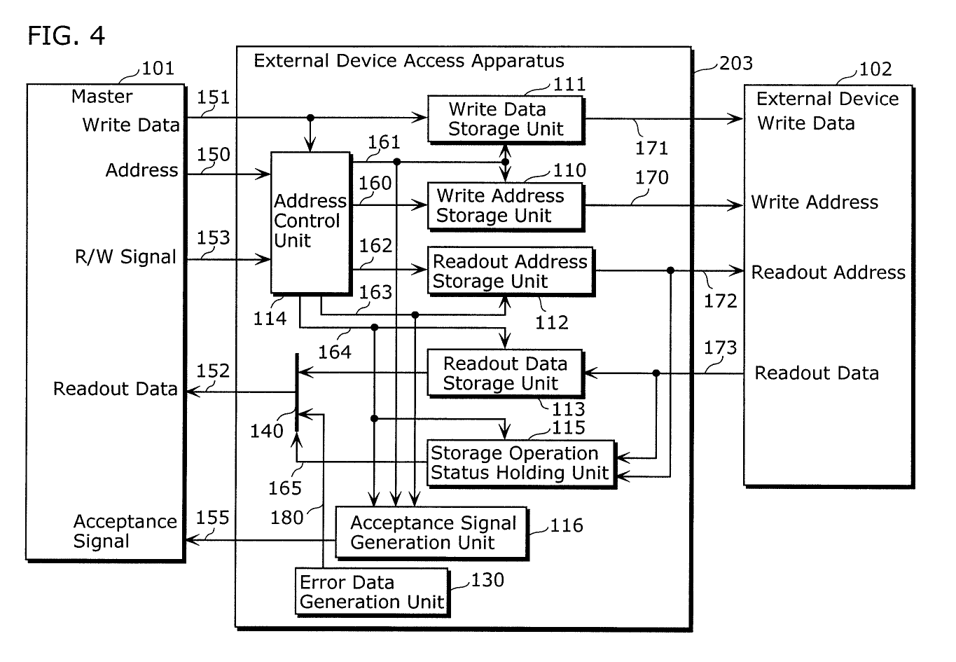

FIG. 4 is a block diagram illustrating the configuration of the external device access apparatus according to the second embodiment of the present invention. Note that identical reference numerals are assigned to the same constituent elements as those shown in FIG. 2, and redundant descriptions thereof will be omitted.

An external device access apparatus 203 according to the second embodiment is configured in the same manner as the external device access apparatus 103 according to the first embodiment, but also includes an error data generation unit 130 and a selector 140.

The external device access apparatus 203 also differs from that of the first embodiment in that the external device access apparatus 203 is not connected to the master 101 via the prefetch operation status signal bus 156.

The error data generation unit 130 generates pre-set error data 180 and outputs the error data 180 to the selector 140.

The selector 140 selects the readout data stored in the readout data storage unit 113 or the error data 180 outputted by the error data generation unit 130 based on a prefetch operation status signal 165 outputted by the storage operation status holding unit 115, and outputs the selected readout data or error data 180 to the readout data output bus 152. To be more specific, in the case where the prefetch operation status signal 165 indicates that a prefetch operation is underway, the selector 140 selects the error data 180, whereas in the case where the prefetch operation status signal 165 indicates that a prefetch operation is not underway, the selector 140 selects the readout data.

Next, operations of the external device access apparatus 203 will be described. Note that descriptions of operations identical to those in the first embodiment will be omitted.

The normal writing operation and the prefetch operation are the same as in the first embodiment.

The prefetch data readout operation will be described hereinafter.

In the prefetch data readout operation, in the case where the prefetch operation status signal 165 outputted by the storage operation status holding unit 115 indicates that the prefetch operation is underway, the selector 140 selects the error data 180 and outputs the selected error data 180 to the readout data output bus 152. Meanwhile, in the case where the prefetch operation status signal 165 indicates that the prefetch operation is not underway, the selector 140 selects the readout data stored in the readout data storage unit 113 and outputs the selected readout data to the readout data output bus 152.

Through this, in the case where the data outputted through the readout data output bus 152 is the pre-set error data 180, the master 101 can determine that the prefetch operation is being executed, whereas in the case where the data outputted through the readout data output bus 152 is not the error data 180, the master 101 can determine that the prefetch operation is complete.

As a result, in addition to the advantages of the external device access apparatus 103 according to the first embodiment, the external device access apparatus 203 according to the second embodiment of the present invention has an advantage in that the prefetch operation status signal bus 156 need not be provided between the external device access apparatus 203 and the master 101.

Note that in the case where the prefetch operation is being executed, the external device access apparatus 103 may output the readout address outputted by the readout address storage unit 112 instead of the error data 180.

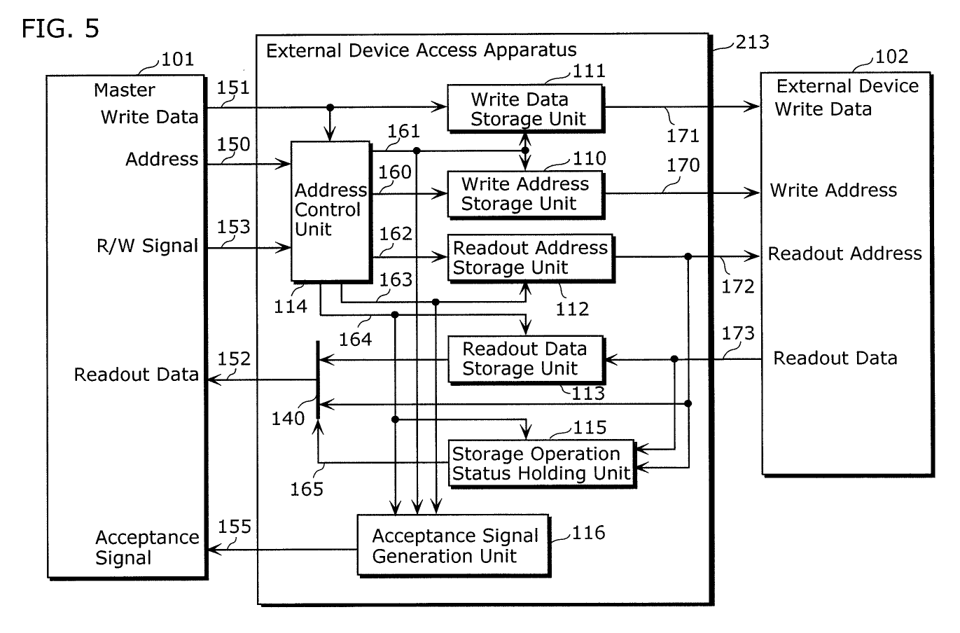

FIG. 5 is a diagram illustrating the configuration of a variation on the external device access apparatus 203 according to the second embodiment of the present invention.

An external device access apparatus 213 illustrated in FIG. 5 does not include the error data generation unit 130, and furthermore, the readout address stored in the readout address storage unit 112 is inputted into the selector 140 instead of the error data 180. In the case where the prefetch operation status signal 165 indicates that the prefetch operation is underway, the selector 140 selects the readout address stored in the readout address storage unit 112 and outputs the selected readout address to the readout data output bus 152.

Through this, in the case where the data outputted through the readout data output bus 152 is the readout address where the prefetch operation is underway, the master 101 can determine that the prefetch operation is being executed.

### Third Embodiment

An external device access apparatus according to a third embodiment of the present invention is a variation on the external device access apparatus 103 according to the aforementioned first embodiment. The external device access apparatus according to the third embodiment further performs a prefetch execution status readout operation that outputs information indicating whether or not a prefetch operation has been completed.

First, the configuration of the external device access apparatus according to the third embodiment of the present invention will be described.

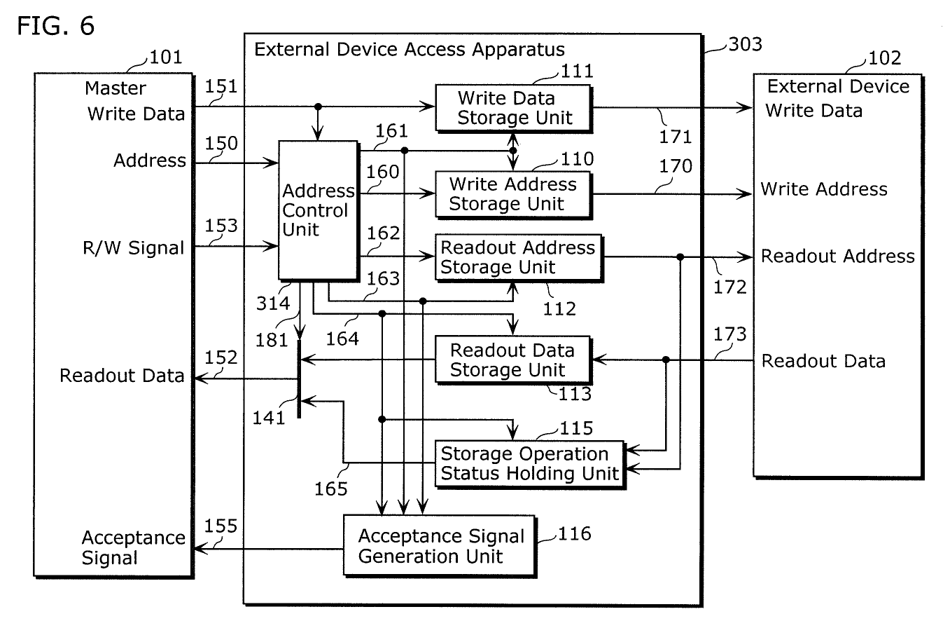

FIG. 6 is a block diagram illustrating the configuration of the external device access apparatus according to the third embodiment of the present invention. Note that identical reference numerals are assigned to the same constituent elements as those shown in FIG. 2, and redundant descriptions thereof will be omitted.

An external device access apparatus 303 according to the third embodiment is configured in the same manner as the external device access apparatus 103 according to the first embodiment, but also includes a selector 141. In addition, the external device access apparatus 303 differs from the external device access apparatus 103 in the configuration of an address control unit 314.

The external device access apparatus 303 also differs from that of the first embodiment in that the external device access apparatus 303 is not connected to the master 101 via the prefetch operation status signal bus 156.

In addition to the normal writing operation, the prefetch operation, and the prefetch data readout operation, the external device access apparatus 303 performs the prefetch execution status readout operation.

The prefetch execution status readout operation is an operation for outputting, to the master 101, information indicating whether or not the prefetch operation is currently being executed. In addition, the storage operation status holding unit 115 holds an address allocated to an access space held by the master 101, and is capable of being accessed by the master 101.

In addition to the functionality of the address control unit 114, the address control unit 314 also accepts a request for a prefetch execution status readout operation (called a “prefetch execution status readout request” hereinafter) from the master 101. To be more specific, in the case where the address outputted through the address bus 150 is an address that has been allocated to the storage operation status holding unit 115 and a data readout has been instructed by the R/W signal, the address control unit 314 recognizes that the request from the master 101 is the prefetch execution status readout request, and accepts the prefetch execution status readout request.

The address control unit 314 performs the prefetch execution status readout operation in response to the prefetch execution status readout request. The address control unit 314 performs the prefetch execution status readout operation by controlling the readout data storage unit 113 and the selector 141.

To be more specific, upon accepting the prefetch execution status readout request, the address control unit 314 outputs the readout data enabling signal 164 and a storage operation status readout enabling signal 181.

In the case where the storage operation status readout enabling signal 181 has not been outputted by the address control unit 314, the selector 141 selects the readout data stored in the readout data storage unit 113 and outputs the selected readout data to the readout data output bus 152. Meanwhile, in the case where the storage operation status readout enabling signal 181 has been outputted by the address control unit 314, the selector 141 selects the prefetch operation status signal 165 stored in a storage operation status holding unit 115 and outputs the selected prefetch operation status signal 165 to the readout data output bus 152.

Next, operations of the external device access apparatus 303 will be described. Note that descriptions of operations identical to those in the first embodiment will be omitted.

The normal writing operation and the prefetch operation are the same as in the first embodiment.

The prefetch data readout operation will be described hereinafter.

In the prefetch data readout operation, the storage operation status readout enabling signal 181 has not been outputted by the address control unit 314, and thus the selector 141 selects the readout data stored in the readout data storage unit 113 and outputs the selected readout data to the readout data output bus 152.

The prefetch execution status readout operation will be described next.

At the time of the prefetch execution status readout operation, the master 101 outputs the address allocated to the storage operation status holding unit 115 to the address bus 150, and outputs the R/W signal instructing a data readout to the R/W signal bus 153.

The address control unit 314 determines whether or not the address on the address bus 150 is the address allocated to the readout data storage unit 113 and whether or not the address on the address bus 150 is the address allocated to the storage operation status holding unit 115. Because the address on the address bus 150 is the address allocated to the storage operation status holding unit 115, and because a data readout has been instructed by the R/W signal, the address control unit 314 recognizes that the request from the master 101 is for the prefetch execution status readout operation.

The address control unit 314 outputs the readout data enabling signal 164 to the readout data storage unit 113, the storage operation status holding unit 115, and the acceptance signal generation unit 116, and outputs the storage operation status readout enabling signal 181 to the selector 141.

Meanwhile, based on the readout data enabling signal 164, the storage operation status holding unit 115 outputs the prefetch operation status signal 165.

Meanwhile, because the storage operation status readout enabling signal 181 has been outputted by the address control unit 314, the selector 141 selects the prefetch operation status signal 165 and outputs the selected prefetch operation status signal 165 to the readout data output bus 152.

Based on the readout data enabling signal 164, the acceptance signal generation unit 116 outputs the acceptance signal to the acceptance signal bus 155.

The prefetch execution status readout operation is completed through the operations described thus far.

As described thus far, in addition to the advantages of the external device access apparatus 103 according to the first embodiment, the external device access apparatus 303 according to the third embodiment of the present invention has an advantage in that the prefetch operation status signal bus 156 need not be provided between the external device access apparatus 303 and the master 101.

Furthermore, the present embodiment has an effect in that by performing the prefetch execution status readout operation before performing the prefetch data readout operation, the master 101 need not perform unnecessary prefetch data readout operations.

### Fourth Embodiment

An external device access apparatus according to a fourth embodiment of the present invention is a variation on the external device access apparatus 103 according to the aforementioned first embodiment. The external device access apparatus according to the fourth embodiment outputs, to the master 101, an external device status signal indicating a status of the external device 102.

First, the configuration of the external device access apparatus according to the fourth embodiment of the present invention will be described.

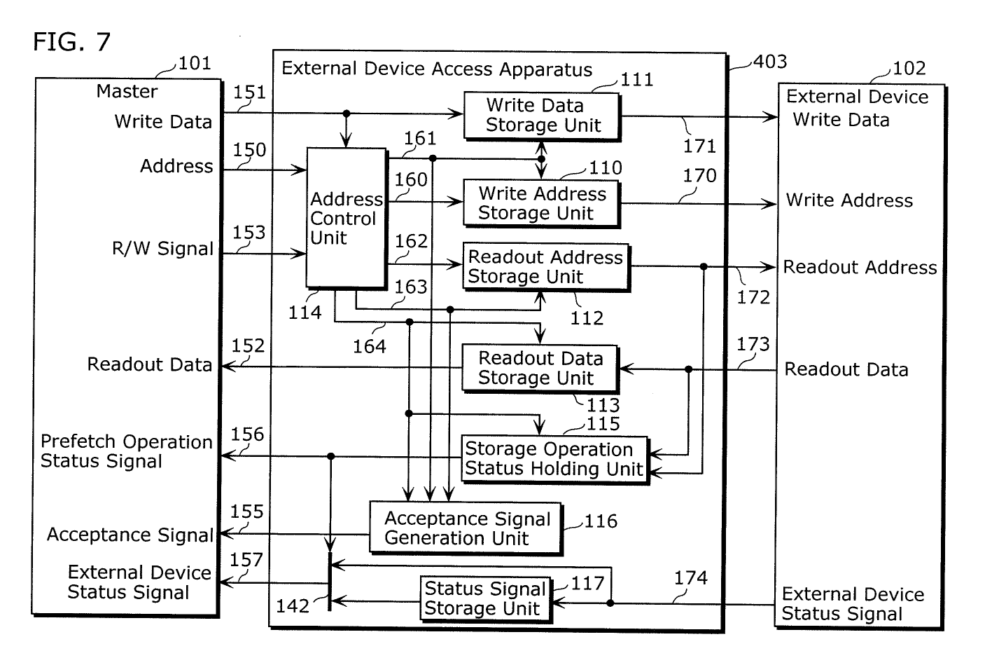

FIG. 7 is a block diagram illustrating the configuration of the external device access apparatus according to the fourth embodiment of the present invention. Note that identical reference numerals are assigned to the same constituent elements as those shown in FIG. 2, and redundant descriptions thereof will be omitted.

An external device access apparatus 403 according to the fourth embodiment is configured in the same manner as the external device access apparatus 103 according to the first embodiment, but also includes a status signal storage unit 117 and a selector 142.

Furthermore, in addition to the connection relationship illustrated in the first embodiment, the external device access apparatus 403 is connected to the master 101 via an external device status signal output bus 157 and to the external device 102 via an external device status signal input bus 174.

In addition, the external device 102 outputs the external device status signal to the external device status signal input bus 174. The external device status signal is a signal indicating the operational status of the external device 102, and is a signal that indicates, for example, an error status, or that write or readout operations are underway due to access by another master.

When the prefetch operation has been completed, the status signal storage unit 117 acquires and stores the external device status signal outputted by the external device 102 through the external device status signal input bus 174. The status signal storage unit 117 then outputs the stored external device status signal to the selector 142.

Based on the prefetch operation status signal outputted through the prefetch operation status signal bus 156, the selector 142 selects the external device status signal outputted through the external device status signal input bus 174 or the external device status signal stored in the status signal storage unit 117, and outputs the selected external device status signal to the external device status signal output bus 157. To be more specific, in the case where the prefetch operation status signal indicates that the prefetch operation is underway, the selector 142 selects the external device status signal on the external device status signal input bus 174, whereas in the case where the prefetch operation status signal indicates that the prefetch operation is not underway, the selector 142 selects the external device status signal stored in the status signal storage unit 117.

Next, operations of the external device access apparatus 403 will be described. Note that descriptions of operations identical to those in the first embodiment will be omitted.

The normal writing operation is the same as in the first embodiment.

With respect to the prefetch operation, once the prefetch operation has been completed, the status signal storage unit 117 acquires and stores the external device status signal on the external device status signal input bus 174.

The prefetch data readout operation will be described hereinafter.

In the prefetch data readout operation, in the case where the prefetch operation status signal outputted by the storage operation status holding unit 115 indicates that the prefetch operation is underway, the selector 142 outputs the external device status signal on the external device status signal input bus 174 to the external device status signal output bus 157. On the other hand, in the case where the prefetch operation status signal indicates that the prefetch operation is not underway, the selector 142 outputs the external device status signal stored in the status signal storage unit 117 to the external device status signal output bus 157.

As described thus far, in the case where a prefetch is being executed, the external device access apparatus 403 notifies the master 101 of the current status of the external device 102, and in the case where the prefetch operation has been completed, notifies the master 101 of the status of the external device 102 when that prefetch operation is completed.

As a result, in addition to the advantages of the external device access apparatus 103 according to the first embodiment, the external device access apparatus 403 according to the fourth embodiment of the present invention has an advantage in that the master 101 can be aware of the status of the external device 102 that is in the process of executing a prefetch. Accordingly, the master 101 can perform the optimum process based on the status of the external device 102.

### Fifth Embodiment

An external device access apparatus according to a fifth embodiment of the present invention is a variation on the external device access apparatus 403 according to the aforementioned fourth embodiment. In the case where a prefetch operation is being executed, the external device access apparatus according to the fifth embodiment selects between outputting an acceptance signal immediately or outputting an acceptance signal after the prefetch operation has been completed, depending on the status of the external device 102.

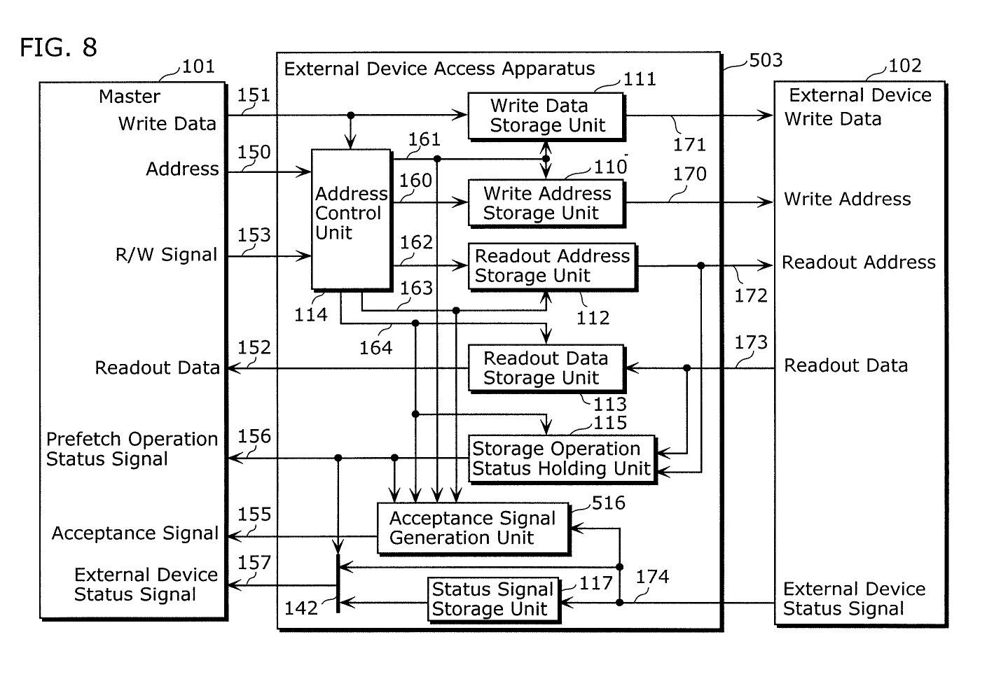

FIG. 8 is a block diagram illustrating the configuration of the external device access apparatus according to the fifth embodiment of the present invention. Note that identical reference numerals are assigned to the same constituent elements as those shown in FIG. 7, and redundant descriptions thereof will be omitted.

An external device access apparatus 503 according to the fifth embodiment is configured in the same manner as the external device access apparatus 403 according to the fourth embodiment, with the exception of the configuration of an acceptance signal generation unit 516.

When a prefetch data readout request has been accepted, the acceptance signal generation unit 516 selectively performs a process for outputting the acceptance signal to the master 101 regardless of whether or not the prefetch operation has been completed or a process for outputting the acceptance signal to the master 101 after the prefetch operation has been completed, in response to the external device status signal on the external device status signal input bus 174.

To be more specific, the acceptance signal generation unit 516 selects an operation for outputting the acceptance signal to the acceptance signal bus 155 based on the readout data enabling signal 164, the prefetch operation status signal outputted by the storage operation status holding unit 115, and the external device status signal on the external device status signal input bus 174.

In the case where the prefetch operation status signal indicates that the prefetch operation is not underway, the acceptance signal generation unit 516 outputs the acceptance signal to the acceptance signal bus 155 when the readout data enabling signal 164 has been outputted by the address control unit 114.

Meanwhile, in the case where the prefetch operation status signal indicates that the prefetch operation is underway and the external device status signal indicates that the external device 102 is operating normally, the acceptance signal generation unit 516 outputs the acceptance signal to the acceptance signal bus 155 after the prefetch operation has been completed.

Furthermore, in the case where the prefetch operation status signal indicates that the prefetch operation is underway and the external device status signal indicates that the external device 102 is in an error state, the acceptance signal generation unit 516 outputs the acceptance signal to the acceptance signal bus 155 when the readout data enabling signal 164 has been outputted by the address control unit 114, without waiting for the completion of the prefetch operation.

Through the configuration described thus far, in the case where a prefetch operation is being executed, the external device access apparatus 503 according to the fifth embodiment selects between outputting the acceptance signal immediately or outputting the acceptance signal after the prefetch operation has been completed, depending on the status of the external device 102.

Through this, even with an external device 102 whose latency until the completion of the prefetch is normally variable, the master 101 need not always carry out the prefetch data readout operation having provided the maximum latency interval, and may instead carry out the prefetch data readout operation having provided the minimum latency interval. Accordingly, the external device access apparatus 503 according to the fifth embodiment of the present invention is capable of utilizing the master 101 even more efficiently.

### Sixth Embodiment

An external device access apparatus according to a sixth embodiment of the present invention is a variation on the external device access apparatus 403 according to the aforementioned fourth embodiment. The external device access apparatus according to the sixth embodiment furthermore carries out a prefetch stopping operation that stops a prefetch operation.

First, the configuration of the external device access apparatus according to the sixth embodiment of the present invention will be described.

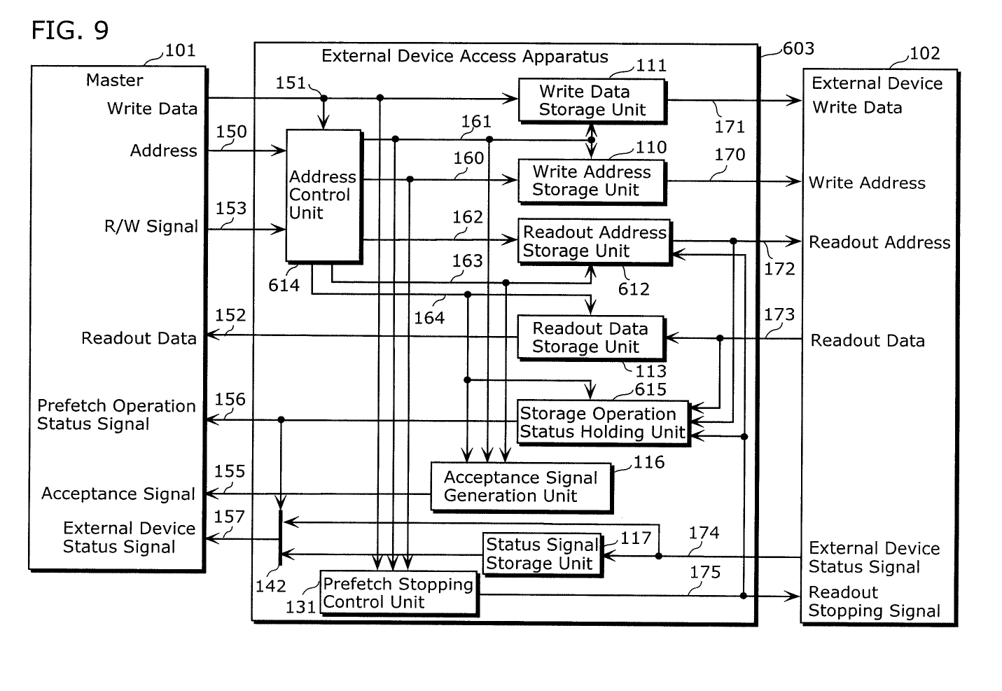

FIG. 9 is a block diagram illustrating the configuration of the external device access apparatus according to the sixth embodiment of the present invention. Note that identical reference numerals are assigned to the same constituent elements as those shown in FIG. 7, and redundant descriptions thereof will be omitted.

An external device access apparatus 603 according to the sixth embodiment is configured in the same manner as the external device access apparatus 403 according to the fourth embodiment, with the exception of the configurations of a readout address storage unit 612 and a storage operation status holding unit 615. Furthermore, in addition to the configuration of the external device access apparatus 403, the external device access apparatus 603 also includes a prefetch stopping control unit 131.

Meanwhile, in addition to the connection relationship described in the fourth embodiment, the external device access apparatus 603 is connected to the external device 102 via a readout stopping signal bus 175.

In addition to the normal writing operation, the prefetch operation, and the prefetch data readout operation, the external device access apparatus 603 performs the prefetch stopping operation.

The prefetch stopping operation is an operation for stopping a prefetch operation that is currently being executed. Meanwhile, the prefetch stopping control unit 131 holds an address allocated to an access space held by the master 101, and is capable of being accessed by the master 101.

In addition to the functionality of the address control unit 114, an address control unit 614 also accepts a request for the prefetch stopping operation (called a “prefetch stopping request” hereinafter) from the master 101. To be more specific, in the case where the address outputted through the address bus 150 is the address allocated to the prefetch stopping control unit 131 and a data write has been instructed by the R/W signal, the address control unit 614 recognizes that the request from the master 101 is the prefetch stopping request, and accepts the prefetch stopping request.

The address control unit 614 performs the prefetch stopping operation in response to the prefetch stopping request. The address control unit 614 performs the prefetch stopping operation by controlling the prefetch stopping control unit 131.

To be more specific, upon receiving the prefetch stopping request, the address control unit 614 outputs the write address 160 and the write enabling signal 161 to the prefetch stopping control unit 131.

The prefetch stopping control unit 131 outputs a readout stopping signal to the readout stopping signal bus 175 based on the write data from the write data input bus 151, the write address 160, and the write enabling signal 161. To be more specific, in the case where the write address 160 is the address allocated to the prefetch stopping control unit 131 and the write data on the write data input bus 151 is of a predetermined value, the prefetch stopping control unit 131 outputs the readout stopping signal to the readout stopping signal bus 175 when the write enabling signal 161 has been outputted by the address control unit 614.

In the case where the readout stopping signal has been outputted by the prefetch stopping control unit 131, the readout address storage unit 612 deletes the held readout address. Meanwhile, in the case where the readout stopping signal has been outputted by the prefetch stopping control unit 131, the storage operation status holding unit 615 deletes the information, indicating that the storage operation is underway, that the storage operation status holding unit 615 held.

In the case where the readout stopping signal has been outputted through the readout stopping signal bus 175 by the prefetch stopping control unit 131, the external device 102 stops the readout process that is currently being executed.

Next, operations of the external device access apparatus 603 will be described. Note that descriptions of operations identical to those in the fourth embodiment will be omitted.

The normal writing operation, the prefetch operation, and the prefetch data readout operation are the same as in the fourth embodiment.

The prefetch stopping operation will be described hereinafter.

At the time of the prefetch execution status readout operation, the master 101 outputs the address allocated to the prefetch stopping control unit 131 to the address bus 150, and outputs the R/W signal instructing a data write to the R/W signal bus 153.

The address control unit 614 determines whether or not the address on the address bus 150 is the address allocated to the readout data storage unit 113 and whether or not the address on the address bus 150 is the address allocated to the prefetch stopping control unit 131. Because the address on the address bus 150 is the address allocated to the prefetch stopping control unit 131, and because a data write has been instructed by the R/W signal, the address control unit 614 recognizes that the request from the master 101 is for the prefetch stopping operation.

The address control unit 614 outputs the write enabling signal 161 to the write data storage unit 111, and outputs the write enabling signal 161 and the address on the address bus 150 to the prefetch stopping control unit 131 as the write address 160.

To be more specific, because the write address 160 is the address allocated to the prefetch stopping control unit 131 and the write data on the write data input bus 151 is of a predetermined value, the prefetch stopping control unit 131 outputs the readout stopping signal to the readout stopping signal bus 175 when the write enabling signal 161 has been outputted by the address control unit 614.

Based on the readout stopping signal, the readout address storage unit 612 deletes the held readout address. Meanwhile, based on the readout stopping signal, the storage operation status holding unit 615 deletes the held information indicating that the storage process is underway.

Based on the readout stopping signal, the external device 102 stops the readout operation that is currently being executed.

The prefetch stopping operation is completed through the operations described thus far.

As described thus far, the external device access apparatus 603 according to the sixth embodiment stops the prefetch operation in response to a request from the master 101. Accordingly, the master 101 can stop the prefetch operation based on the status of the external device 102. As a result, in addition to the advantages of the external device access apparatus 403 according to the fourth embodiment, the external device access apparatus 603 according to the sixth embodiment of the present invention has an advantage in that the external device 102 can be used even more efficiently.

### Seventh Embodiment

An external device access apparatus according to a seventh embodiment of the present invention is a variation on the external device access apparatus 603 according to the aforementioned sixth embodiment. The external device access apparatus according to the seventh embodiment stops the prefetch operation based on the status of the external device 102 in the case where the prefetch operation is being executed when prefetch data is read out.

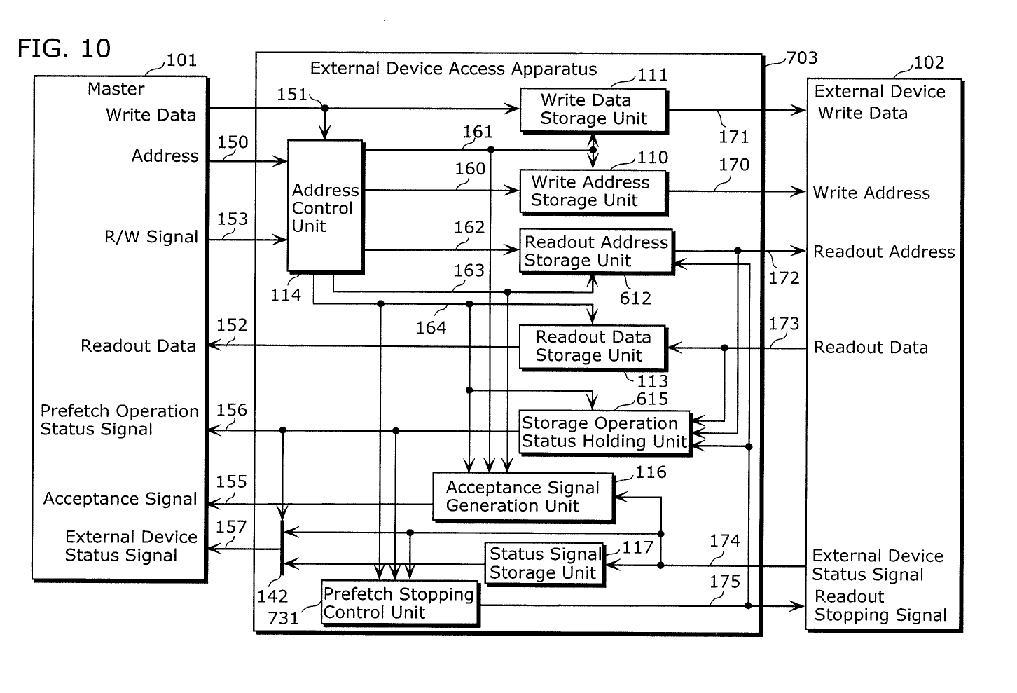

FIG. 10 is a block diagram illustrating the configuration of the external device access apparatus according to the seventh embodiment of the present invention. Note that identical reference numerals are assigned to the same constituent elements as those shown in FIG. 9, and redundant descriptions thereof will be omitted.

An external device access apparatus 703 according to the seventh embodiment is configured in the same manner as the external device access apparatus 603 according to the sixth embodiment, with the exception of the configuration of a prefetch stopping control unit 731.

In addition, the external device access apparatus 703 performs the normal writing operation, the prefetch operation, and the prefetch data readout operation, but does not perform the prefetch stopping operation in response to a request from the master 101.

The configuration of the address control unit 114, meanwhile, is the same as that in the fourth embodiment.

In the case where the prefetch data readout request has been accepted and the prefetch operation status signal on the prefetch operation status signal bus 156 indicates that the prefetch operation has not been completed, the prefetch stopping control unit 731 performs control so as to stop the prefetch operation, based on the external device status signal on the external device status signal input bus 174.

To be more specific, in the case where the prefetch operation status signal indicates that the prefetch operation is underway and the external device status signal indicates that the external device 102 is in an error state, the prefetch stopping control unit 731 outputs the readout stopping signal to the readout stopping signal bus 175 when the readout data enabling signal 164 has been outputted by the address control unit 114.

Through the configuration described thus far, in the case where the prefetch operation is being executed and the external device 102 is in an error state at the time of the prefetch data readout operation, the external device access apparatus 703 stops the prefetch operation. Through this, the master 101 need not request the prefetch stopping operation. As a result, in addition to the advantages of the external device access apparatus 603 according to the sixth embodiment, the external device access apparatus 703 according to the seventh embodiment of the present invention has an advantage in that the processing performed by the master 101 can be reduced.

### Eighth Embodiment

An external device access apparatus according to an eighth embodiment of the present invention is a variation on the external device access apparatus 403 according to the aforementioned fourth embodiment. The external device access apparatus according to the eighth embodiment outputs the prefetch operation status signal 165 to the external device status signal output bus 157 in the case where a prefetch is being executed.

First, the configuration of the external device access apparatus according to the eighth embodiment of the present invention will be described.

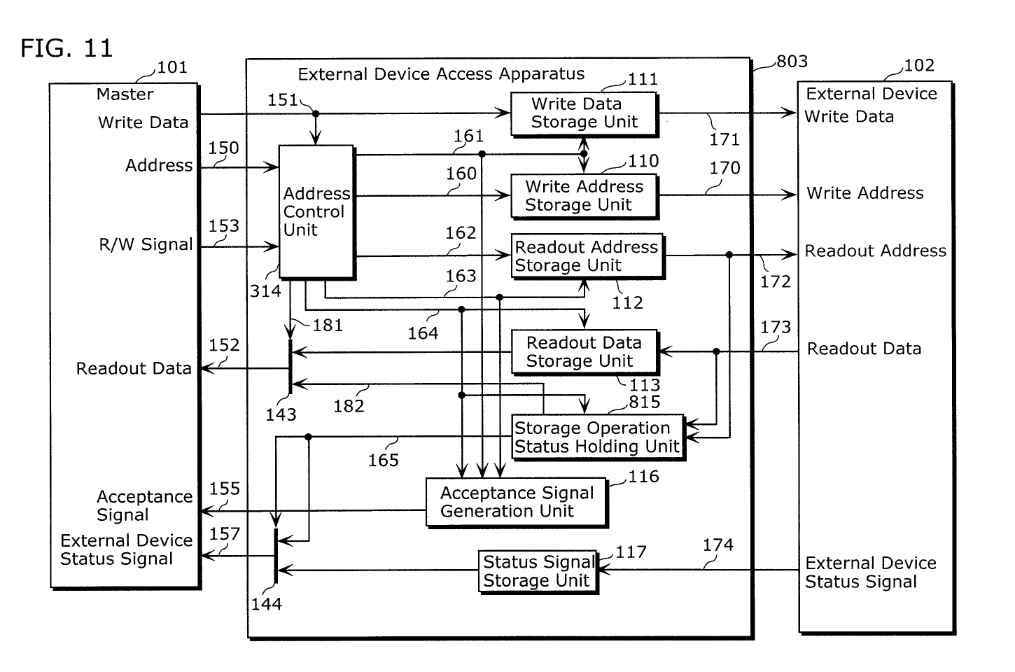

FIG. 11 is a block diagram illustrating the configuration of the external device access apparatus according to the eighth embodiment of the present invention. Note that identical reference numerals are assigned to the same constituent elements as those shown in FIGS. 6 and 7, and redundant descriptions thereof will be omitted.

An external device access apparatus 803 according to the eighth embodiment is configured in the same manner as the external device access apparatus 403 according to the fourth embodiment, with the exception of the configurations of a storage operation status holding unit 815, a selector 144, and the address control unit 314. Note that the configuration of the address control unit 314 is the same as that in the third embodiment. Meanwhile, in addition to the configuration of the external device access apparatus 403, the external device access apparatus 803 also includes a selector 143.

In addition to the functionality of the storage operation status holding unit 115, the storage operation status holding unit 815 furthermore stores a prefetch data readout time status signal 182, which indicates a prefetch operation status at the time when the prefetch data readout request is accepted. In other words, the prefetch data readout time status signal 182 indicates the execution status of the prefetch operation at the time of a prefetch data readout. The storage operation status holding unit 815 outputs the stored prefetch data readout time status signal 182 to the selector 143.

In the case where the storage operation status readout enabling signal 181 has not been outputted by the address control unit 314, the selector 143 selects the readout data stored in the readout data storage unit 113 and outputs the selected readout data to the readout data output bus 152. On the other hand, in the case where the storage operation status readout enabling signal 181 has been outputted by the address control unit 314, the selector 143 selects the prefetch data readout time status signal 182 outputted by the storage operation status holding unit 815 and outputs the selected prefetch data readout time status signal 182 to the readout data output bus 152.

Based on the prefetch operation status signal 165, the selector 144 selects the prefetch operation status signal 165 or the external device status signal stored in the status signal storage unit 117 and outputs the selected prefetch operation status signal 165 or the external device status signal to the external device status signal output bus 157. To be more specific, in the case where the prefetch operation status signal 165 indicates that the prefetch operation is underway, the selector 144 selects the prefetch operation status signal 165, whereas in the case where the prefetch operation status signal indicates that the prefetch operation is not underway, the selector 144 selects the external device status signal stored in the status signal storage unit 117.

Next, operations of the external device access apparatus 803 will be described. Note that descriptions of operations identical to those in the fourth embodiment will be omitted.

The normal writing operation and the prefetch operation are the same as in the fourth embodiment.

The prefetch data readout operation will be described hereinafter.

In the prefetch data readout operation, the storage operation status readout enabling signal 181 has not been outputted by the address control unit 314, and thus the selector 143 selects the readout data stored in the readout data storage unit 113 and outputs the selected readout data to the readout data output bus 152.

Meanwhile, in the case where the prefetch operation is being executed, the selector 144 outputs the prefetch operation status signal 165 to the external device status signal output bus 157, and in the case where the prefetch operation has been completed, the selector 144 outputs the status signal stored in the status signal storage unit 117 to the external device status signal output bus 157.

Meanwhile, the storage operation status holding unit 115 stores the prefetch execution status at the time of that prefetch data readout operation.

As described thus far, in the prefetch data readout operation, the external device access apparatus 803 outputs the readout data stored in the readout data storage unit 113 to the readout data output bus 152. In addition, in the case where the prefetch operation is being executed, the prefetch operation status signal 165 is outputted to the external device status signal output bus 157.

Through this, the master 101 can determine whether or not the external device access apparatus 803 is executing the prefetch operation at the time of the prefetch data readout operation.

The prefetch execution status readout operation will be described next.

In the prefetch execution status readout operation, because the storage operation status readout enabling signal 181 has been outputted by the address control unit 314, the selector 143 selects the prefetch data readout time status signal 182 outputted by the storage operation status holding unit 815 and outputs the selected prefetch data readout time status signal 182 to the readout data output bus 152.

Meanwhile, in the case where the prefetch operation is being executed, the selector 144 outputs the prefetch operation status signal 165 to the external device status signal output bus 157, and in the case where the prefetch operation has been completed, the selector 144 outputs the status signal stored in the status signal storage unit 117 to the external device status signal output bus 157.

As described thus far, the external device access apparatus 803 according to the eighth embodiment outputs the prefetch operation status signal 165 to the external device status signal output bus 157 in the case where the prefetch operation is being executed during the prefetch execution status readout operation.

Through this, the master 101 can determine whether or not the external device access apparatus 803 is executing the prefetch operation by requesting the prefetch execution status readout operation.

Meanwhile, in the case where the prefetch operation has been completed during the prefetch execution status readout operation, the external device access apparatus 803 outputs the prefetch data readout time status signal 182, indicating whether or not the prefetch operation was being executed at the time of the prefetch readout operation, to the readout data output bus 152, and outputs the status of the external device 102 at the time of the prefetch readout operation to the external device status signal output bus 157.

Through this, the master 101 can be aware of the status of the external device 102 that is executing a prefetch.

As described thus far, in addition to the advantages of the external device access apparatus 303 according to the third embodiment and the external device access apparatus 403 according to the fourth embodiment, the external device access apparatus 803 according to the eighth embodiment of the present invention has an advantage in that the prefetch operation status signal bus 156 and the external device status signal output bus 157 can be implemented as a single entity.

### Ninth Embodiment

An external device access apparatus according to a ninth embodiment of the present invention is a variation on the external device access apparatus 103 according to the aforementioned first embodiment. The external device access apparatus according to the ninth embodiment selects between outputting an acceptance signal immediately or outputting an acceptance signal after the prefetch operation has been completed, in response to a readout acceptance control signal outputted by the master 101.

First, the configuration of the external device access apparatus according to the ninth embodiment of the present invention will be described.

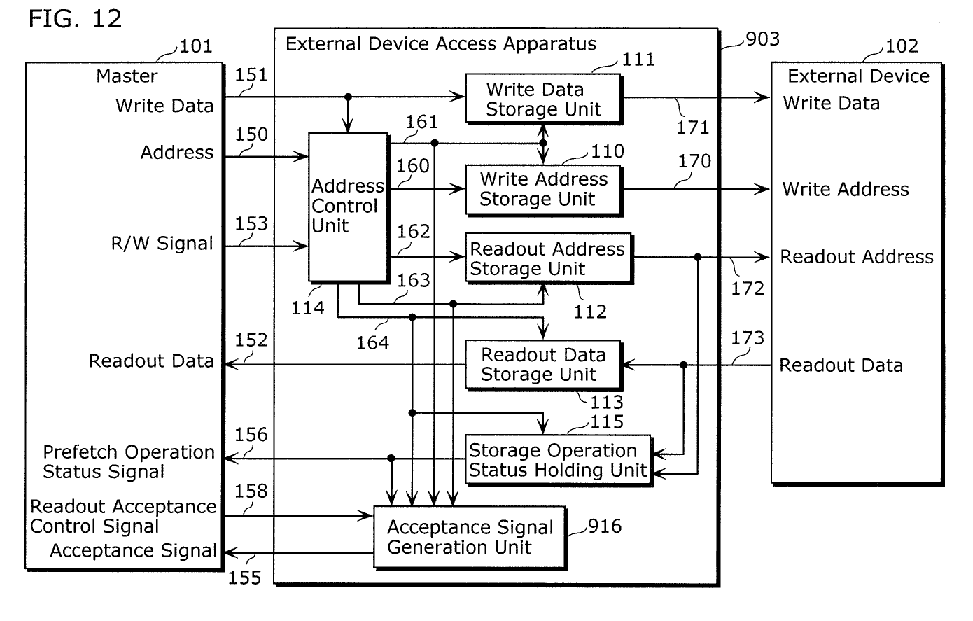

FIG. 12 is a block diagram illustrating the configuration of the external device access apparatus according to the ninth embodiment of the present invention. Note that identical reference numerals are assigned to the same constituent elements as those shown in FIG. 2, and redundant descriptions thereof will be omitted.

An external device access apparatus 903 according to the ninth embodiment is configured in the same manner as the external device access apparatus 103 according to the first embodiment, with the exception of the configuration of an acceptance signal generation unit 916.

Furthermore, in addition to the connection relationship of the first embodiment, the external device access apparatus 903 is connected to the master 101 via a readout acceptance control signal bus 158.

When the prefetch data readout request has been accepted, the acceptance signal generation unit 916 selectively performs an operation for outputting an acceptance signal to the master 101 regardless of whether or not the prefetch operation has been completed or an operation for outputting the acceptance signal to the master 101 after the prefetch operation has been completed, based on the prefetch operation status signal on the prefetch operation status signal bus 156 and the readout acceptance control signal on the readout acceptance control signal bus 158.

To be more specific, in the case where the prefetch operation status signal indicates that the prefetch operation is not underway, the acceptance signal generation unit 916 outputs the acceptance signal to the acceptance signal bus 155 when the readout data enabling signal 164 has been outputted by the address control unit 114.

Meanwhile, in the case where the prefetch operation status signal indicates that the prefetch operation is underway and the readout acceptance control signal indicates a first logic, the acceptance signal generation unit 916 outputs the acceptance signal to the acceptance signal bus 155 after the prefetch operation has been completed.

Meanwhile, in the case where the prefetch operation status signal indicates that the prefetch operation is underway and the readout acceptance control signal indicates a second logic, the acceptance signal generation unit 916 outputs the acceptance signal to the acceptance signal bus 155 when the readout data enabling signal 164 has been outputted by the address control unit 114, without waiting for the completion of the prefetch operation.

Through this configuration described thus far, the external device access apparatus 903 according to the ninth embodiment selects, in the case where the prefetch operation is being executed, whether to immediately output the acceptance signal or to output the acceptance signal after the prefetch operation has been completed, based on the readout acceptance control signal on the readout acceptance control signal bus 158.

As a result, the master 101 can selectively cause the external device access apparatus 903 to perform the operations in the aforementioned first embodiment or an operation for returning the acceptance signal after the prefetch operation has been completed.

Note that the master 101 may output the readout acceptance control signal in synchronization with the prefetch data readout request in response to a command from a CPU, a microprocessor, or the like. Through this, the master 101 can select between two processes with each prefetch readout operation. Accordingly, the master 101 can perform a more optimum process.

Meanwhile, although the preceding described the two processes as being selected based on the readout acceptance control signal outputted to the readout acceptance control signal bus 158, two addresses may be allocated to the readout data storage unit 113, and the two processes may be selected by selecting one of those two addresses.

To be more specific, in the case where a first address of the two addresses allocated to the readout data storage unit 113 has been outputted by the master 101, the address control unit 114 accepts a first prefetch data readout request for immediately outputting the acceptance signal. Meanwhile, in the case where a second address of the two addresses allocated to the readout data storage unit 113 has been outputted by the master 101, the address control unit 114 accepts a second prefetch data readout request for outputting the acceptance signal after the prefetch operation has been completed.

The address control unit 114 outputs, to the acceptance signal generation unit 916, a control signal based on whether the prefetch data readout request is the first prefetch data readout request or the second prefetch data readout request.

Based on this control signal, the acceptance signal generation unit 916 may perform an operation for immediately outputting the acceptance signal in the case where the first prefetch data readout request has been accepted, and may perform an operation for outputting the acceptance signal after the prefetch operation has been completed in the case where the second prefetch data readout request has been accepted.

### Tenth Embodiment

An external device access apparatus according to a tenth embodiment of the present invention is a variation on the external device access apparatus 103 according to the aforementioned first embodiment. The external device access apparatus according to the tenth embodiment performs a prefetch readout control operation that sets whether to output an acceptance signal immediately or output the acceptance signal after the prefetch operation has been completed.

First, the configuration of the external device access apparatus according to the tenth embodiment of the present invention will be described.

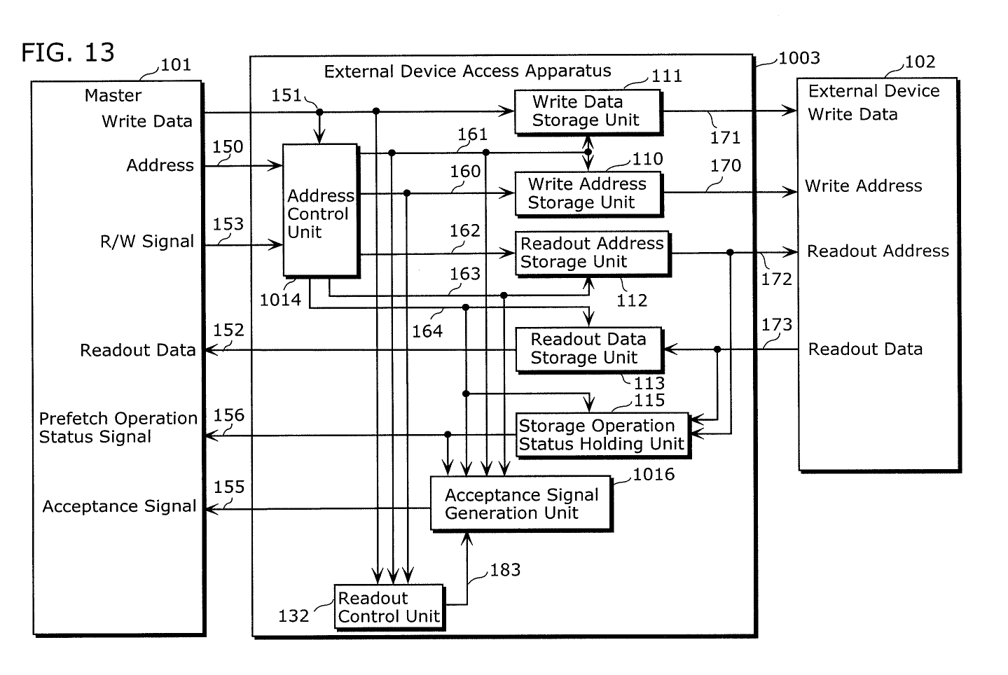

FIG. 13 is a block diagram illustrating the configuration of the external device access apparatus according to the tenth embodiment of the present invention. Note that identical reference numerals are assigned to the same constituent elements as those shown in FIG. 2, and redundant descriptions thereof will be omitted.

An external device access apparatus 1003 according to the tenth embodiment is configured in the same manner as the external device access apparatus 103 according to the first embodiment, but further includes a readout control unit 132. In addition, the configurations of an address control unit 1014 and an acceptance signal generation unit 1016 in the external device access apparatus 1003 differ with respect to the external device 102.

In addition to the normal writing operation, the prefetch operation, and the prefetch data readout operation, the external device access apparatus 1003 performs the prefetch readout control operation.

The prefetch readout control operation is an operation for setting, in the case where a prefetch operation is being executed at the time of the prefetch data readout operation, whether to output an acceptance signal immediately or to output the acceptance signal after the prefetch operation has been completed. Meanwhile, the readout control unit 132 holds an address allocated to an access space held by the master 101, and is capable of being accessed by the master 101.

In addition to the functionality of the address control unit 114, the address control unit 1014 also accepts a request for the prefetch readout control operation (called a “prefetch readout control request” hereinafter) from the master 101. To be more specific, in the case where the address outputted through the address bus 150 is the address allocated to the readout control unit 132 and a data write has been instructed by the R/W signal, the address control unit 1014 recognizes that the request from the master 101 is the prefetch readout control request, and accepts the prefetch readout control request.

The address control unit 1014 performs the prefetch readout control operation in response to the prefetch readout control request. The address control unit 1014 performs the prefetch readout control operation by controlling the readout control unit 132.

To be more specific, upon receiving the prefetch readout control request, the address control unit 1014 outputs the write address 160 and the write enabling signal 161 to the readout control unit 132.

When the readout control unit 132 has accepted a prefetch readout control request, a readout control signal 183, indicating whether to output the acceptance signal immediately or output the acceptance signal after the prefetch operation has been completed, is set based on an instruction from the master 101. The readout control unit 132 outputs the set readout control signal 183 to the acceptance signal generation unit 1016.

To be more specific, when the write address 160 is the address allocated to the readout control unit 132, and the write enabling signal 161 has been outputted by the address control unit 1014, the readout control unit 132 holds the readout control signal 183 based on the write data on the write data input bus 151.

The acceptance signal generation unit 1016 outputs the acceptance signal to the acceptance signal bus 155 based on the readout data enabling signal 164, the prefetch operation status signal outputted by the storage operation status holding unit 115, and the readout control signal 183.

To be more specific, in the case where the prefetch operation status signal indicates that the prefetch operation is not underway, the acceptance signal generation unit 1016 outputs the acceptance signal to the acceptance signal bus 155 when the readout data enabling signal 164 has been outputted by the address control unit 114.

Meanwhile, in the case where the prefetch operation status signal indicates that the prefetch operation is underway and the readout control signal 183 indicates that the acceptance signal is to be outputted after the prefetch operation has been completed, the acceptance signal generation unit 1016 outputs the acceptance signal to the acceptance signal bus 155 after the prefetch operation has been completed.

Furthermore, in the case where the prefetch operation status signal indicates that the prefetch operation is underway and the readout control signal 183 indicates that the acceptance signal is to be outputted immediately, the acceptance signal generation unit 1016 outputs the acceptance signal to the acceptance signal bus 155 when the readout data enabling signal 164 has been outputted by the address control unit 114, without waiting for the completion of the prefetch operation.

Next, operations of the external device access apparatus 1003 will be described.

The normal writing operation and the prefetch operation are the same as in the first embodiment.

The prefetch data readout operation will be described hereinafter.

At the time of the prefetch data readout operation, the acceptance signal generation unit 1016 selects whether to output the acceptance signal immediately or output the acceptance signal after the prefetch operation has been completed, based on the readout control signal 183.

To be more specific, in the case where the readout control signal 183 indicates that the acceptance signal is to be outputted after the prefetch operation has been completed, the acceptance signal generation unit 1016 outputs the acceptance signal to the acceptance signal bus 155 after the prefetch operation has been completed.

Meanwhile, in the case where the readout control signal 183 indicates that the acceptance signal is to be outputted immediately, the acceptance signal generation unit 1016 outputs the acceptance signal to the acceptance signal bus 155 when the readout data enabling signal 164 has been outputted by the address control unit 114, without waiting for the completion of the prefetch operation.

The prefetch readout control operation will be described hereinafter.

At the time of the prefetch readout control operation, the master 101 outputs the address allocated to the readout control unit 132 to the address bus 150, and outputs the R/W signal instructing a data write to the R/W signal bus 153.

The address control unit 1014 determines whether or not the address on the address bus 150 is the address allocated to the readout data storage unit 113 and whether or not the address on the address bus 150 is the address allocated to the readout control unit 132. Because the address on the address bus 150 is the address allocated to the readout control unit 132, and because a data write has been instructed by the R/W signal, the address control unit 1014 recognizes that the request from the master 101 is for the prefetch readout control operation.

The address control unit 1014 outputs the write enabling signal 161 to the write data storage unit 111, and outputs the write enabling signal 161 and the address on the address bus 150 to the readout control unit 132 as the write address 160.

Because the write address 160 is the address allocated to the readout control unit 132, when the write enabling signal 161 has been outputted by the address control unit 614, the readout control unit 132 stores the readout control signal 183 based on the write data on the write data input bus 151, and outputs the stored readout control signal 183 to the acceptance signal generation unit 1016.

Meanwhile, based on the write enabling signal 161 outputted by the address control unit 1014, the acceptance signal generation unit 1016 outputs the acceptance signal to the acceptance signal bus 155 at the point in time when the readout control unit 132 has stored the readout control signal 183.

As described thus far, with the external device access apparatus 1003, whether to output the acceptance signal immediately or output the acceptance signal after the prefetch operation has been completed is set through the prefetch readout control operation. As a result, the master 101 can switch between having the external device access apparatus 1003 perform the operations of the aforementioned first embodiment or an operation for returning the acceptance signal after the prefetch operation has been completed.

Furthermore, as opposed to the external device access apparatus 903 according to the ninth embodiment, the external device access apparatus 1003 according to the tenth embodiment has an advantage in that it is not necessary to additionally provide the readout acceptance control signal bus 158 between the external device access apparatus 1003 and the master 101.

### Eleventh Embodiment

An external device access apparatus according to an eleventh embodiment of the present invention is a variation on the external device access apparatus 103 according to the aforementioned first embodiment. The external device access apparatus according to the eleventh embodiment outputs, in the case where a prefetch operation is underway at the time of a prefetch data readout, debug information, which is information indicating the amount of time from when a prefetch data readout request was made by the master 101 to when the prefetch operation has been completed.

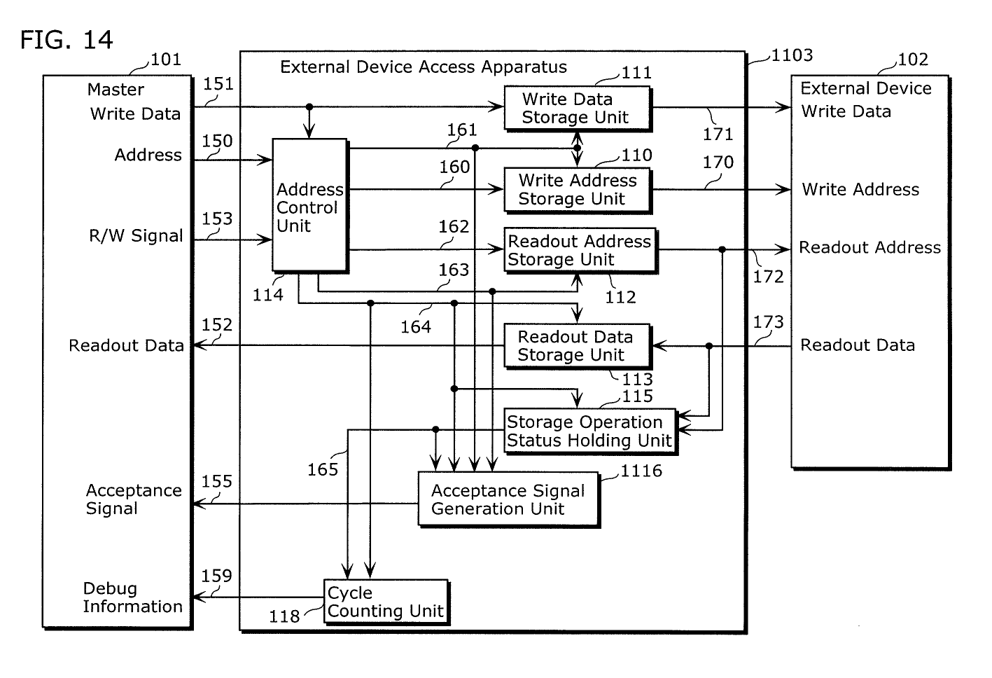

FIG. 14 is a block diagram illustrating the configuration of the external device access apparatus according to the eleventh embodiment of the present invention. Note that identical reference numerals are assigned to the same constituent elements as those shown in FIG. 2, and redundant descriptions thereof will be omitted.

An external device access apparatus 1103 according to the eleventh embodiment is configured in the same manner as the external device access apparatus 103 according to the first embodiment, but further includes a cycle count unit 118. In addition, the configuration of an acceptance signal generation unit 1116 in the external device access apparatus 1103 differs with respect to the external device 102.

Meanwhile, in addition to the connection relationship of the external device access apparatus 103, the external device access apparatus 1103 is connected to the master 101 via a debug information bus 159. The external device access apparatus 1103 is, however, not connected to the master 101 via the prefetch operation status signal bus 156.

In the case where the prefetch operation status signal 165 indicates that the prefetch operation is not underway, the acceptance signal generation unit 1116 outputs the acceptance signal to the acceptance signal bus 155 when the readout data enabling signal 164 has been outputted by the address control unit 114.

Meanwhile, in the case where the prefetch operation status signal 165 indicates that the prefetch operation is underway, the acceptance signal generation unit 1116 outputs the acceptance signal to the acceptance signal bus 155 after the prefetch operation has been completed.

In the case where the prefetch data readout request has been accepted while the prefetch operation is being executed, the cycle count unit 118 counts the amount of time from when the prefetch data readout request was accepted to when the prefetch operation is completed. To be more specific, the cycle count unit 118 counts the number of cycles from when the readout data enabling signal 164 is outputted by the address control unit 114 to when the prefetch operation status signal 165 held by the storage operation status holding unit 115 changes from indicating that the prefetch operation is being executed to indicating that the prefetch operation has been completed. The cycle count unit 118 outputs the counted number of cycles to the debug information bus 159 as the debug information.

Through the configuration described thus far, the external device access apparatus 1103 according to the eleventh embodiment outputs, in the case where the prefetch operation is being executed at the time of the prefetch data readout operation, debug information, which is information indicating the amount of time from when the prefetch data readout request was made by the master 101 to when the prefetch operation has been completed, to the debug information bus 159.

As a result, the master 101 can change the timing at which the prefetch data readout operation is requested to a time that is after the completion of the prefetch operation. Accordingly, because the master 101 need not request the prefetch data readout operation multiple times, the efficiency can be improved.

### Twelfth Embodiment

An external device access apparatus according to a twelfth embodiment of the present invention is a variation on the external device access apparatus 1103 according to the aforementioned eleventh embodiment. The external device access apparatus according to the twelfth embodiment performs a debug information readout operation that outputs the debug information to the readout data output bus 152.

First, the configuration of the external device access apparatus according to the twelfth embodiment of the present invention will be described.

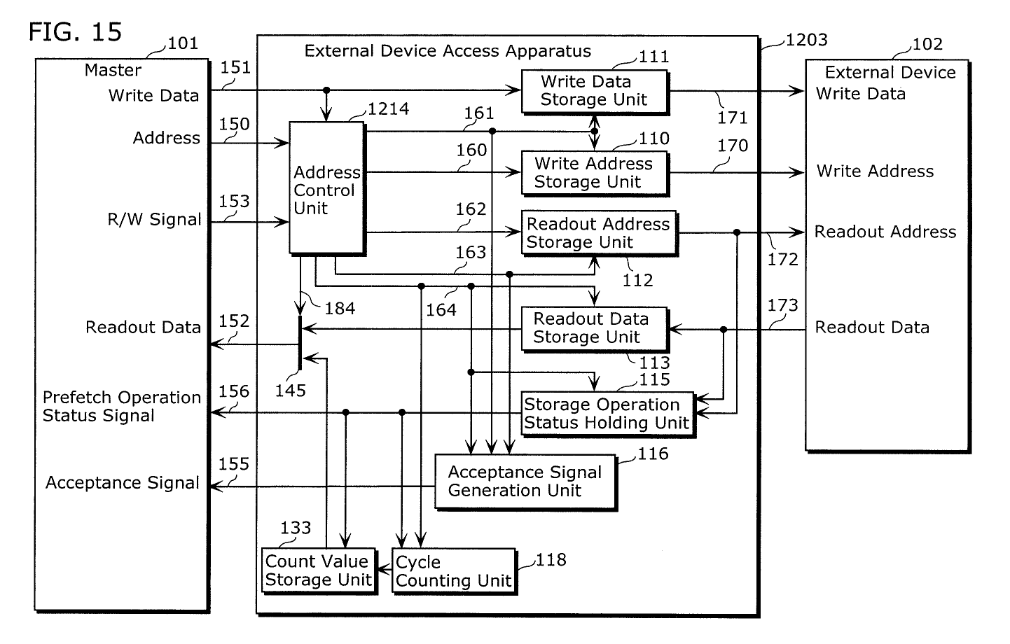

FIG. 15 is a block diagram illustrating the configuration of the external device access apparatus according to the twelfth embodiment of the present invention. Note that identical reference numerals are assigned to the same constituent elements as those shown in FIG. 14, and redundant descriptions thereof will be omitted.

An external device access apparatus 1203 according to the twelfth embodiment is configured in the same manner as the external device access apparatus 1103 according to the eleventh embodiment, but also includes a count value storage unit 133 and a selector 145. In addition, the external device access apparatus 1203 differs from the external device access apparatus 1103 in the configuration of an address control unit 1214. Note that the configuration of the acceptance signal generation unit 116 is the same as in the first embodiment.

As with the connection relationship in the first embodiment, the external device access apparatus 1203 is connected to the master 101 via the prefetch operation status signal bus 156, but is not connected to the master 101 via the debug information bus 159.

In addition to the normal writing operation, the prefetch operation, and the prefetch data readout operation, the external device access apparatus 1203 performs the debug information readout operation.

The debug information readout operation is an operation in which debug information, which is information indicating, in the case where the prefetch operation is being executed at the time of the prefetch data readout operation, the amount of time from when the prefetch data readout request was made by the master 101 to when the prefetch operation has been completed. Here, the count value storage unit 133 holds an address allocated to an access space held by the master 101, and is capable of being accessed by the master 101.

The count value storage unit 133 stores the debug information outputted by the cycle count unit 118 when the prefetch operation status signal on the prefetch operation status signal bus 156 changes from indicating that the prefetch operation is being executed to indicating that the prefetch operation has been completed.

In addition to the functionality of the address control unit 114, the address control unit 1214 also accepts a request for the debug information readout operation (called a “debug information readout request” hereinafter) from the master 101. To be more specific, in the case where the address outputted through the address bus 150 is the address allocated to the count value storage unit 133 and a data write is instructed by the R/W signal, the address control unit 1214 recognizes that the request from the master 101 is the debug information readout request, and accepts the debug information readout request.

The address control unit 1214 performs the debug information readout operation in response to the debug information readout request. The address control unit 1214 performs the debug information readout operation by controlling the selector 145.

To be more specific, when the debug information readout request has been accepted, the address control unit 1214 outputs a count value readout enabling signal 184 to the selector 145.

The selector 145 selects the readout data stored in the readout data storage unit 113 or the debug information stored in the count value storage unit 133 based on the count value readout enabling signal 184 outputted by the address control unit 1214, and outputs the selected readout data or debug information to the readout data output bus 152. To be more specific, in the case where the count value readout enabling signal 184 is not being outputted by the address control unit 1214, the selector 145 selects the readout data, whereas in the case where the count value readout enabling signal 184 is being outputted by the address control unit 1214, the selector 145 selects the debug information.

Next, operations of the external device access apparatus 1203 will be described. Note that descriptions of operations identical to those in the eleventh embodiment will be omitted.

The normal writing operation and the prefetch operation are the same as in the eleventh embodiment.

The prefetch data readout operation will be described hereinafter.

With respect to the prefetch data readout operation, in the case where the prefetch data readout operation has been performed while the prefetch operation is being executed, the cycle count unit 118 counts the number of cycles from when the prefetch data readout operation was performed to when the prefetch operation is completed. The cycle count unit 118 outputs the counted number of cycles to the count value storage unit 133 as the debug information.

The count value storage unit 133 stores the debug information outputted by the cycle count unit 118 when the prefetch operation status signal on the prefetch operation status signal bus 156 changes from indicating that the prefetch operation is being executed to indicating that the prefetch operation has been completed.

Meanwhile, because the count value readout enabling signal 184 has not been outputted by the address control unit 1214, the selector 145 outputs the readout data stored in the readout data storage unit 113 to the readout data output bus 152.

The debug information readout operation will be described hereinafter.

At the time of the debug information readout operation, the master 101 outputs the address allocated to the count value storage unit 133 to the address bus 150, and outputs the R/W signal instructing a data readout to the R/W signal bus 153.

The address control unit 1214 determines whether or not the address on the address bus 150 is the address allocated to the readout data storage unit 113 and whether or not the address on the address bus 150 is the address allocated to the count value storage unit 133. Because the address on the address bus 150 is the address allocated to the count value storage unit 133, and because a data readout has been instructed by the R/W signal, the address control unit 1214 recognizes that the request from the master 101 is for the debug information readout operation.

The address control unit 1214 outputs the count value readout enabling signal 184 to the selector 145.

Because the count value readout enabling signal 184 has been outputted by the address control unit 1214, the selector 145 outputs the debug information stored in the count value storage unit 133 to the readout data output bus 152.

Through this, the debug information readout operation is completed.

The external device access apparatus 1203 according to the twelfth embodiment outputs the debug information to the readout data output bus 152 through the debug information readout operation.

As a result, the master 101 can change the timing at which the prefetch data readout operation is requested to a time that is after the completion of the prefetch operation. Accordingly, because the master 101 need not request the prefetch data readout operation multiple times, the efficiency can be improved.

In addition, as opposed to the external device access apparatus 1103 according to the eleventh embodiment, the external device access apparatus 1203 has an advantage in that it is not necessary to provide the debug information bus 159 between the external device access apparatus 1203 and the master 101.

### INDUSTRIAL APPLICABILITY

The present invention can be applied in an external device access apparatus and a system LSI that includes a master such as a CPU or a microprocessor and an external device such as a coprocessor or an accelerator.

1. An external device access apparatus that performs, in response to a request from a master, a prefetch operation of reading out data from an external device and a prefetch data readout operation of outputting the data read out through the prefetch operation to the master, said apparatus comprising:
a control unit configured to accept a prefetch request and a prefetch data readout request from the master and perform the prefetch operation and the prefetch data readout operation;
a data storage unit configured to store the data read out through the prefetch operation;
a status holding unit configured to hold a prefetch operation status indicating whether or not the prefetch operation has been completed; and
an acceptance signal generation unit configured to output, to the master, an acceptance signal indicating that the prefetch data readout request from the master has been accepted,
wherein said control unit is configured to output the data stored in said data storage unit to the master as the prefetch data readout operation; and
said control unit is configured to output first information indicating a status of the prefetch operation to the master, the status being based on the prefetch operation status.

2. The external device access apparatus according to claim 1,
wherein said acceptance signal generation unit is configured to output the acceptance signal to the master, regardless of whether or not the prefetch operation has been completed, when the prefetch data readout request is accepted by said control unit; and
said control unit is configured to output the first information to the master upon accepting the prefetch data readout request.

3. The external device access apparatus according to claim 1,
wherein said control unit is configured to output the prefetch operation status to the master as the first information.

4. The external device access apparatus according to claim 1,
wherein said external device access apparatus and the master are connected via a readout data bus; and
said control unit is configured to output the data stored in said data storage unit and the first information to the master via the readout data bus.

5. The external device access apparatus according to claim 4,
wherein said control unit is configured to output the data stored in said data storage unit to the master via the readout data bus in the case where the prefetch operation status indicates that the prefetch operation has been completed, and output pre-set data as the first information to the master via the readout data bus in the case where the prefetch operation status indicates that the prefetch operation has not been completed.

6. The external device access apparatus according to claim 4,
wherein said control unit is configured to output the data stored in said data storage unit to the master via the readout data bus in the case where the prefetch operation status indicates that the prefetch operation has been completed, and output an address of the external device, for which the readout is being performed through the prefetch operation, as the first information to the master via the readout data bus in the case where the prefetch operation status indicates that the prefetch operation has not been completed.

7. The external device access apparatus according to claim 1,
wherein said control unit is further configured to accept a prefetch operation status readout request from the master; and
said control unit is configured to output the first information to the master in the case where the prefetch operation status readout request has been accepted.

8. The external device access apparatus according to claim 1,
wherein the external device outputs a status signal indicating an operational status of the external device, and
said external device access apparatus further comprises:
a status signal storage unit configured to store the status signal at the point in time of the completion of the prefetch operation; and
a status signal output unit configured to output the status signal stored in said status signal storage unit to the master in the case where the prefetch operation status indicates that the prefetch operation has been completed, and output the status signal outputted by the external device to the master in the case where the prefetch operation status indicates that the prefetch operation has not been completed.

9. The external device access apparatus according to claim 1,
wherein the external device outputs a status signal indicating an operational status of the external device, and
said acceptance signal generation unit is configured to selectively perform, when the prefetch data readout request has been accepted by said control unit and based on the status signal, a first operation that outputs the acceptance signal to the master regardless of whether or not the prefetch operation has been completed or a second operation that outputs the acceptance signal to the master after the prefetch operation has been completed.

10. The external device access apparatus according to claim 8,
wherein said control unit is further configured to accept a prefetch stopping request from the master, and
said external device access apparatus further comprises
a prefetch stopping unit configured to stop the prefetch operation in the case where the prefetch stopping request has been accepted by said control unit.

11. The external device access apparatus according to claim 1,
wherein the external device outputs a status signal indicating an operational status of the external device, and
said external device access apparatus further comprises
a prefetch stopping unit configured to stop the prefetch operation based on the status signal outputted by the external device in the case where the prefetch data readout request has been accepted by said control unit and the prefetch operation status indicates that the prefetch operation has not been completed.

12. The external device access apparatus according to claim 7,
wherein the external device outputs a status signal indicating an operational status of the external device;
said external device access apparatus and the master are connected via a first signal bus; and
said external device access apparatus further comprises:
a status signal storage unit configured to store the status signal at the point in time of the completion of the prefetch operation;
a readout time status storage unit configured to store a readout time prefetch operation status that is the prefetch operation status at the point in time when the prefetch data readout request has been accepted by said control unit; and
a signal output unit configured to output the prefetch operation status to the master via the first signal bus in the case where the prefetch operation status indicates that the prefetch operation has not been completed, and output the status signal stored in said status signal storage unit to the master via the first signal bus in the case where the prefetch operation status indicates that the prefetch operation has been completed,
wherein said control unit is configured to output the readout time prefetch operation status to the master as the first information in the case where the prefetch operation status readout request has been accepted.

13. The external device access apparatus according to claim 1,
wherein said acceptance signal generation unit is configured to selectively perform, when the prefetch data readout request has been accepted by said control unit, a first operation that outputs the acceptance signal to the master regardless of whether or not the prefetch operation has been completed or a second operation that outputs the acceptance signal to the master after the prefetch operation has been completed.

14. The external device access apparatus according to claim 13,
wherein said acceptance signal generation unit is configured to selectively perform the first operation or the second operation, based on a control signal outputted by the master.

15. The external device access apparatus according to claim 13,
wherein the prefetch data readout request includes a first prefetch data readout request and a second prefetch data readout request;
said control unit is configured to accept the first prefetch data readout request in the case where a first address has been outputted by the master, and accept the second prefetch data readout request in the case where a second address has been outputted by the master; and
said acceptance signal generation unit is configured to perform the first operation in the case where the first prefetch data readout request has been accepted by said control unit, and perform the second operation in the case where the second prefetch data readout request has been accepted by said control unit.

16. The external device access apparatus according to claim 13, further comprising
a status setting unit in which a first status or a second status is set,
wherein said control unit is further configured to accept a prefetch readout control operation request from the master;
said control unit sets the first status or the second status in said status setting unit as instructed by the master in the case where the prefetch readout control operation request has been accepted; and
said acceptance signal generation unit is configured to perform the first operation in the case where the first status is set in said status setting unit, and perform the second operation in the case where the second status is set in said status setting unit.

17. The external device access apparatus according to claim 1, further comprising
a count unit configured to, in the case where a prefetch data readout request has been accepted by said control unit while the prefetch operation is being executed, count the time from when the prefetch data readout request is accepted until the prefetch operation is completed,
wherein said control unit outputs the time counted by said count unit as the first information to the master.

18. The external device access apparatus according to claim 17,
wherein said control unit is further configured to accept a time readout request from the master, and
said external device access apparatus further comprises
a time storage unit configured to store the time counted by said count unit,
wherein said control unit outputs the time stored in said time storage unit as the first information to the master in the case where a time readout request has been accepted.

19. A system LSI comprising the external device access apparatus according to claim 1 and a master,
wherein said external device access apparatus outputs the first information as an interrupt signal or as a thread switching signal for said master, and
said master processes the first information as an interrupt or as a thread switching signal.

20. A system LSI comprising the external device access apparatus according to claim 1 and a master,
wherein said external device access apparatus outputs the first information as a flag signal that can be processed by said master through software, and
said master processes the first information as a flag signal that can be processed through software.

21. A system LSI comprising the external device access apparatus according to claim 14 and a master,
wherein said master outputs the control signal to said external device access apparatus in synchronization with the prefetch data readout request.

22. A control method for an external device access apparatus that performs, in response to a request from a master, a prefetch operation of reading out data from an external device and a prefetch data readout operation of outputting the data read out in the prefetch operation to the master, said method comprising:
accepting a prefetch request from the master;
reading out data from the external device and storing the read-out data in a data storage unit in the case where the prefetch request has been accepted;
holding a prefetch operation status indicating whether or not said storing has been completed;
accepting a prefetch data readout request from the master;
outputting, to the master, an acceptance signal indicating that the prefetch data readout request has been accepted in the case where the prefetch data readout request has been accepted;
outputting the data stored in said data storage unit to the master in the case where the prefetch data readout request has been accepted; and
outputting first information indicating a status of the prefetch operation to the master based on the prefetch operation status.
